(19) United States
(12) Patent Application Publication
(10) Pub. No.: US 2022/0019903 A1
(43) Pub. Date: Jan. 20, 2022

(54) ASSIGNMENT DEVICE, ASSIGNMENT METHOD, AND PROGRAM

(71) Applicant: NEC Corporation, Tokyo (JP)

(72) Inventor: Ryoji MIYAZAKI, Tokyo (JP)

(73) Assignee: NEC Corporation, Tokyo (JP)

(21) Appl. No.: 17/372,868

(22) Filed: Jul. 12, 2021

(30) Foreign Application Priority Data
Jul. 17, 2020 (JP) 2020-123262

(51) Int. Cl. G06N 5/00; G06N 10/00

(52) U.S. Cl. CPC G06N 5/003; G06N 10/00

(57) ABSTRACT

An assignment device includes an input receiving unit configured to receive as input the number of cities of a traveling salesman problem, an assignment unit configured to assign, to nodes of a Chimera graph, binary variables according to the number of cities of the traveling salesman problem represented as a QUBO problem, and an output unit configured to output information indicating a correspondence between the binary variables and the nodes on the basis of an assignment result of the binary variables to the nodes. The assignment unit assigns, to the nodes connected to each other by an edge in the Chimera graph, a pair of the binary variables appearing as a product in an objective function of the QUBO problem in preference to a pair of binary variables not appearing as a product in the objective function of the QUBO problem.

### INCORPORATION BY REFERENCE

This application is based upon and claims the benefit of priority from Japanese patent application No. 2020-123262, filed on Jul. 17, 2020, the disclosure of which is incorporated herein in its entirety by reference.

### TECHNICAL FIELD

The present disclosure relates to an assignment device, an assignment method and a program and, particularly, relates to transformation of the traveling salesman problem into a Chimera graph.

### BACKGROUND ART

Transforming the traveling salesman problem into a Chimera graph corresponds to specifying a correspondence between an objective function when representing the traveling salesman problem as the QUBO (Quadratic Unconstrained Binary Optimization) problem and a specific Chimera graph consisting of nodes and edges. Transformation into a Chimera graph is performed because it is necessary when solving the traveling salesman problem by using quantum annealing machines or the like. This transformation is needed when representing the traveling salesman problem as the QUBO problem and solving it by quantum annealing or the like.

To represent the QUBO problem on the Chimera graph, it is generally necessary to properly assign variables of an objective function to nodes.

One example of a method of finding an assignment that satisfies constraints regarding general QUBO problems, not limited to the traveling salesman problem is disclosed in P. I. Bunyk et al, “Architectural Considerations in the Design of a Superconducting Quantum Annealing Processor”, IEEE Transactions on Applied Superconductivity, vol. 24, 2014 (which is referred to hereinafter as Non Patent Literature 1). Another example is disclosed in J. Cai et al., “A practical heuristic for finding graph minors”, arXiv:1406.2741 (2014) (which is referred to hereinafter as Non Patent Literature 2).

### SUMMARY

The method disclosed in Non Patent Literature 1 is applicable to any QUBO problems. However, since this method performs the same assignment for all QUBO problems, it is likely that, for each of QUBO problems, there is an assignment that allows reducing the number of nodes used in a Chimera graph. The method disclosed in Non Patent Literature 2 is a heuristic method. While this method finds an assignment, it is not guaranteed that the same assignment is obtained each time. Particularly, there is no guarantee that the number of nodes used is reduced. Thus, the above-described two methods have a problem that it is not possible or not guaranteed to find an assignment with a small number of nodes used when solving the traveling salesman problem by representing it on a Chimera graph.

The present disclosure has been accomplished to solve the above problems and an object of the present disclosure is thus to provide an assignment device, an assignment method, and a program capable of obtaining a correspondence between variables of the QUBO problem corresponding to the traveling salesman problem and nodes of a graph for solving this QUBO problem with a small number of nodes used.

An assignment device according to a first aspect of the present disclosure includes an input receiving unit configured to receive as input the number of cities of a traveling salesman problem, an assignment unit configured to assign, to nodes of a Chimera graph, binary variables according to the number of cities of the traveling salesman problem represented as a QUBO (Quadratic Unconstrained Binary Optimization) problem, and an output unit configured to output information indicating correspondence between the binary variables and the nodes on the basis of an assignment result of the binary variables to the nodes, wherein the assignment unit assigns, to the nodes connected to each other by an edge in the Chimera graph, a pair of the binary variables appearing as a product in an objective function of the QUBO problem in preference to a pair of binary variables not appearing as a product in the objective function of the QUBO problem.

An assignment method according to a second aspect of the present disclosure includes receiving as input the number of cities of a traveling salesman problem, assigning, to nodes of a Chimera graph, binary variables according to the number of cities of the traveling salesman problem represented as a QUBO problem, and outputting information indicating correspondence between the binary variables and the nodes on the basis of an assignment result of the binary variables to the nodes, wherein in the assignment of the binary variables to the nodes, a pair of binary variables appearing as a product in an objective function of the QUBO problem is assigned to the nodes connected to each other by an edge in the Chimera graph in preference to a pair of binary variables not appearing as a product in the objective function of the QUBO problem.

A program according to a third aspect of the present disclosure causes a computer to execute an input receiving step of receiving as input the number of cities of a traveling salesman problem, an assignment step of assigning, to nodes of a Chimera graph, binary variables according to the number of cities of the traveling salesman problem represented as a QUBO problem, and an output step of outputting information indicating correspondence between the binary variables and the nodes on the basis of an assignment result of the binary variables to the nodes, wherein the assignment step assigns, to the nodes connected to each other by an edge in the Chimera graph, a pair of binary variables appearing as a product in an objective function of the QUBO problem in preference to a pair of binary variables not appearing as a product in the objective function of the QUBO problem.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a schematic view showing a Chimera graph consisting of a 4×4 array of K(4) unit cells;

FIG. 2 is a schematic view showing an example of chains;

FIG. 3 is a schematic view showing that three chains are connected by an edge;

FIG. 4 is a schematic view showing an example of a computation system according to a first embodiment;

FIG. 5 is a block diagram showing an example of a functional configuration of an assignment device according to the first embodiment;

FIG. 6 is a block diagram showing an example of the hardware configuration of an assignment device according to an embodiment;

FIG. 7 is a schematic view showing an example of bundles;

FIG. 8 is a schematic view showing, in blocks, nodes to be used before the fourth process is performed;

FIG. 9 is a schematic view showing, in blocks, nodes to be used after the fourth process is performed;

FIG. 10 is a schematic view showing an example of numbers representing the positions of nodes;

FIG. 11 is a schematic view showing an assignment result at N=5 in the first embodiment;

FIG. 12 is a schematic view showing a group of unit cells used by each bundle in the assignment shown in FIG. 11;

FIG. 13 is a schematic view showing the placement of bundles at the end of the third process;

FIG. 14 is a schematic view showing an assignment result at N=6 in the first embodiment;

FIG. 15 is a schematic view showing a group of unit cells used by each bundle in the assignment shown in FIG. 14;

FIG. 16 is a flowchart showing the flow of the operation of the assignment device according to the first embodiment;

FIG. 17 is a flowchart showing the flow of the computation of the traveling salesman problem (QUBO problem) by a computation system according to an embodiment;

FIG. 18 is a table showing experimental results regarding the traveling salesman problem where the number of cities is 8;

FIG. 19 is a schematic view showing an example of a computation system according to a second embodiment; and

FIG. 20 is a flowchart showing the flow of the operation of an assignment device according to the second embodiment.

### EXAMPLE EMBODIMENTS

In the following description, a subscript of a variable is represented using an underbar in order to clarify that it is a subscript. For example, “x_i” indicates that “i” is a subscript of “x”.

In order to help understand an embodiment, the traveling salesman problem, the QUBO problem, a Chimera graph, representing the traveling salesman problem represented as the QUBO problem on a Chimera graph, and quantum annealing machines associated with them are described hereinafter.

The traveling salesman problem is the problem of finding the shortest possible route when a salesman visits each of given cities exactly once and returns to the origin city, and it is a combinatorial optimization problem that is difficult to solve. A specific problem of the traveling salesman problem is given the number of cities and the distances between each pair of cities. The traveling salesman problem can be represented as the QUBO problem, which is described below.

The QUBO problem is generally represented as follows. First, prepare N variables that can take on values of 0 or 1, which are binary variables. Those variables are represented as x_i, where i can take a value among 1, 2, . . . , N, and x_i is distinguished by a difference in the value of i. Then, an objective function H is defined as the following expression (1).

$$H = {\sum }_{i , j} {Q}_{ij} {x}_{i} {x}_{j} \qquad Expression ( 1 )$$

Q_ij on the right-hand side of the expression (1) is a value in row i and column j of the matrix Q, and i and j can take a value among 1, 2, . . . , N. Q_ij can take on a value of a real number. Since x_i is 0 or 1, x_i×x_i=x_i. Specifically, Q_ii x_i x_i=Q_ii x_i. Thus, the expression (1) is a generic representation of a real-valued coefficient linear or quadratic polynomial consisting of N number of variables x_i that can only take on a value of 0 or 1. Further, even if Q_ij where i>j is all 0, it is sufficiently usable as a generic representation, and therefore assume that Q_ij where i>j is all 0 and consider only Q_ij where i≤j below. The QUBO problem is the problem of finding a combination of values of x_i (i=1, 2, . . . , N) that minimize H of the expression (1) when the matrix Q is specifically given.

The traveling salesman problem can be represented as the QUBO problem. Specifically, the matrix Q corresponding to a specific problem of the traveling salesman problem always exists, and the traveling salesman problem can be represented in the form of the expression (1) by using this matrix Q. Stated differently, the traveling salesman problem can be represented as the problem of finding a combination of variables that yield the minimum value of an objective function, and this objective function can be represented as a real-valued coefficient linear or quadratic polynomial consisting of variables that can only take on a value of 0 or 1. There are a plurality of ways of representing the traveling salesman problem as the QUBO problem. In other words, there are a plurality of corresponding matrices Q. The following expression (2) is one of those representations. In this representation, the objective function H of the QUBO problem is represented by the expression (2).

$$H = {\sum }_{i , j = 0}^{N - 2} {\sum }_{a = 0}^{N - 3} {W}_{ij} {x}_{i , a} {x}_{j , a + 1} + {\sum }_{i = 0}^{N - 2} {W}_{i , N - 1} {x}_{i , N - 2} + {\sum }_{j = 0}^{N - 2} {W}_{N - 1 , j} {x}_{j , 0} + C {\sum }_{a = 0}^{N - 2} {( {\sum }_{i = 0}^{N - 2} {x}_{i , a} - 1 )}^{2} + C {\sum }_{i = 0}^{N - 2} {( {\sum }_{a = 0}^{N - 2} {x}_{i , a} - 1 )}^{2} \qquad Expression ( 2 )$$

In the expression (2), x that is distinguished by a subscript is a binary variable of the QUBO problem. Specifically, in the expression (2), x with a subscript such as x_i,a and x_j,a+1 is a binary variable of the QUBO problem, and it can take on a value of 0 or 1. In this representation, two subscripts are added to each x. The first subscript (i or j) specifies a city of a specific problem of the traveling salesman problem, and this subscript can take on an integer of 0 to N−2, where N indicates the number of cities. The other subscript (a, a+1, N−2, or 0) of x represents in what ordinal position the city is to be visited, and this subscript can take on an integer of 0 to N−2. The reason that the values of those subscripts do not take on N−1 is described later. x_i,a can take on values of 0 or 1, and x_i,a=0 means not visiting city i as a-th city to visit, and x_i,a=1 means visiting city i as a-th city to visit. In this manner, x_i,a is a variable that represents whether or not to visit city i as a-th city to visit. Once all values of x are determined, when they satisfy the below-described constraints, it is uniquely determined which city is to be visited in what ordinal position. Thus, the combination of values of x and the sequence of visiting cities correspond. W_ij is an integer that represents the distance between city i and city j. C is a parameter to be adjusted. As described later, adjusting C allows a combination of values of x that minimizes H to be a solution of the traveling salesman problem. C is a predetermined positive value.

Since the expression (2) is a linear or quadratic polynomial with variables x_i,a that can only take on a value of 0 or 1, it can be represented in the form of the expression (1). Note that, however, the subscripts in the expression (2) and the subscripts in the expression (1) are different. A pair (i,a) of two subscripts i and a in the expression (2) corresponds to i, j, and the like in the expression (1). It is optional which pair of subscripts in the expression (2) and which subscripts in the expression (1) are to correspond to each other. For example, to let (i, a)=(0,0) correspond to i=1 in the expression (1) and let (i, a)=(0, 1) correspond to i=2 in the expression (1), representing the expression (2) in the form of the expression (1) results in Q_11=Q_22=−2C, and Q_12=2C, where W_00=0. Further, to let (i, a)=(1, 1) correspond to i=3 in the expression (1), representing the expression (2) in the form of the expression (1) results in Q_33=−2C, Q_13=W_01, Q_23=2C. In this manner, the expression (2) can be represented in the form of the expression (1), and each element of the matrix Q is represented by W and C. How each element of the matrix Q is represented specifically is obtained by expanding the expression (2) with respect to x and seeing the coefficients.

A requirement for a combination of values of x to uniquely determine a route that travels around cities is to satisfy the following two constraints. The first constraint is that one of the variables x_i,a with the same value of i and different values of a takes on 1, and all the others take on 0, and this holds true for all values of i. The second constraint is that one of the variables x_i,a with the same value of a and different values of i takes on 1, and all the others take on 0, and this holds true for all values of a. Satisfying the first constraint means that the number of times of visiting city i is only once. Satisfying the second constraint means that the number of cities visited as a-th city to visit is only one. Although there can be some combinations of values of x that do not satisfy those constraints, such combinations represent visiting one city a plurality of times or visiting a plurality of cities at one time, which do not correspond to a route to be obtained.

When a combination of values of x meets the requirement to uniquely determine a route that travels around cities, terms with the coefficient C in the expression (2) are 0. Then, H includes only the first three terms (terms other than the terms with the coefficient C) in the expression (2). Further, since W_ij represents the distance between city i and city j, when visiting city i as a-th city to visit and visiting city j as (a+1)th city to visit in a route corresponding to the combination of values of x, W_ij x_i,a x_j,a+1 is W_ij, and otherwise it is 0. Thus, by calculating the sum of W_ij x_i,a x_j,a+1 for all i and j, the distance from a-th city to visit to (a+1)th city to visit in the route corresponding to the combination of values of x is obtained. Further, by calculating the sum for a as well, the total distance of the route corresponding to the combination of values of x is obtained.

Note that, however, some considerations are needed for the distance from (N−2)th city to visit to (N−1)th city to visit and the distance from (N−1)th city to visit to Nth city to visit (which is the same city as the city to visit first). This is because the expression (2) deals with only the route that visits city N−1 as (N−1)th city to visit. There can be routes where the moving route (from which city to which city) is the same but the ordinal position of the city to visit is different. For example, when incrementing the ordinal position number of the city to visit by one and visiting the city, which has been (N−1)th city, as Nth city to visit, a route with the same moving route (from which city to which city) but different ordinal positions of the cities to visit is obtained. Those two routes have the same total distance. To find the route with the shortest distance travelled, what to know is from which city to which city to move. In order to remove this optional dependency, only the route that visits city N−1 as (N−1)th city to visit is considered. Thus, the subscripts i and a of x do not take on N−1. In the expression (2) formed under this concept, the distance from (N−2)th city to visit to (N−1)th city to visit (which is city N−1) is given by taking the sum of W_i,N−1 x_i,N−2 with respect to i. Then, the distance from (N−1)th city to visit (which is city N−1) to Nth city to visit (which is the same city as first (0th) city to visit) is given by taking the sum of W_N−1,j x_j,0 with respect to j.

Given the above, when a requirement for a combination of values of x to uniquely determine a route that travels around cities is satisfied, terms with the coefficient C in the expression (2) are 0, and the other terms are the total distance of the route corresponding to the combination of values of x. Thus, H in the expression (2) obtains the total distance of the route corresponding to the combination of values of x.

On the other hand, when a requirement for a combination of values of x to uniquely determine a route that travels around cities is not satisfied, terms with the coefficient C (positive value) in the expression (2) are positive values, the value of H increases. Thus, by increasing the value of C, the value of H corresponding to the combination of values of x that does not correspond to the route becomes large. Therefore, reducing the value of H leads to not selecting the combination of values of x that does not correspond to the route.

As described above, regarding the traveling salesman problem with specific city locations, when W_ij is given, H in the expression (2) is determined if the parameter C is determined. Since H is the linear or quadratic polynomial with the variable x that can take on 0 or 1, it can be regarded as the objective function of the QUBO problem. Finding the combination of values of x that minimizes H corresponds to finding the shortest route that travels around the cities in those locations. Thus, the traveling salesman problem is represented as the QUBO problem of the expression (2).

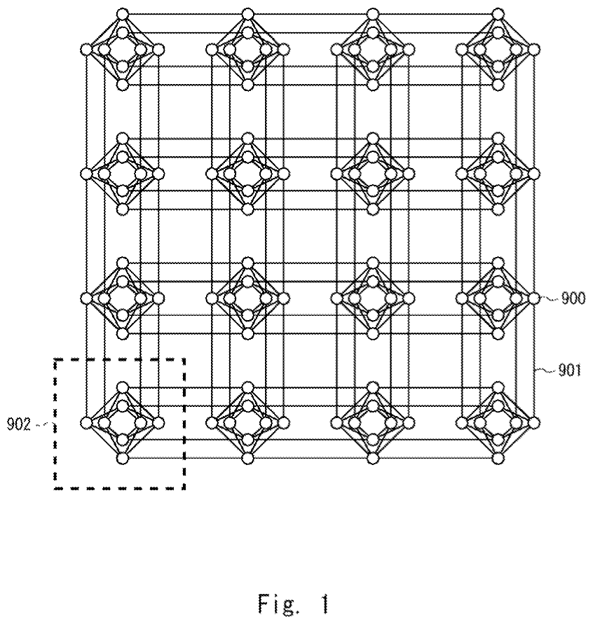

A Chimera graph is described hereinbelow. FIG. 1 is a view showing an example of a Chimera graph. The Chimera graph is composed of a plurality of nodes 900 and edges 901 connecting each pair of the nodes. The Chimera graph comprises an array of the unit cells 902. The unit cell is a unit graph that constitutes the Chimera graph. In the Chimera graph, the unit cells 902 are arranged in a square lattice or in a structure that can be transformed into a square lattice. Consider below a square lattice in vertical and horizontal directions. The Chimera graph is identified by the number of nodes 900 in the unit cell 902 and the number of unit cells 902 in the vertical direction (which is also referred to as the column direction) and in the horizontal direction (which is also referred to as the row direction).

A unit cell of the Chimera graph is represented by K(r). K(r) includes two sets of r number of nodes, which is 2r number of nodes in total, and r nodes in one set are connected to all of r nodes in the other set. Thus, the Chimera graph is a complete bipartite graph with 2r nodes. Of r nodes of the two sets in the unit cell, r nodes in one set are connected by an edge to nodes at the corresponding positions in two adjacent unit cells in the horizontal direction, and r nodes in the other set are connected by an edge to nodes at the corresponding positions in two adjacent unit cells in the vertical direction. Note that, however, a unit cell located at the end of the graph is connected by an edge only to a unit cell on the other side of this end, not connected to two adjacent unit cells. Although FIG. 1 shows the Chimera graph with K(4) unit cells tiled vertically and horizontally in a 4×4 array (total 16), the number of nodes in one unit cell and the number of unit cells are not limited to the example shown in FIG. 1 as described earlier.

Representing the traveling salesman problem represented as the QUBO problem on the Chimera graph is described hereinafter. Representing the traveling salesman problem represented as the QUBO problem on the Chimera graph corresponds to representing the traveling salesman problem as the QUBO problem and appropriately assigning variables in the objective function to the nodes of the Chimera graph. Criteria for appropriateness are described later. The assignment is represented by listing nodes to which variables in the QUBO problem, i.e., variables in the objective function, are to be assigned. One variable may be assigned to a plurality of nodes.

Assigning variables of the objective function to nodes of the Chimera graph allows solving the QUBO problem by machines using a Chimera graph, such as quantum annealing machines. Suppose the use of quantum annealing machines when solving the QUBO problem below, though the use of quantum annealing machines is not compulsory.

The quantum annealing machines have qubits (quantum bits) and coupling between qubits. The qubit largely comprises two states, and which state it is in can be treated as a binary variable. Further, the overall energy of qubits can be defined. One of methods of finding a combination of qubit states with the lowest energy is called quantum annealing. Quantum annealing machines are designed to perform quantum annealing and find a combination of qubit states with the lowest energy. This can be applied to solve the QUBO problem as follows. Let the two states of qubits correspond to the variables in the QUBO problem, and let the overall energy of qubits correspond to the objective function of the QUBO problem. Obtaining the state where the overall energy of qubits is low by a quantum annealing machine thereby leads to finding a combination of variables that reduces the value of the objective function of the corresponding QUBO problem.

To let the overall energy of qubits of the quantum annealing machine correspond to the objective function of the QUBO problem, it is necessary to let the two states of qubits correspond to variables in the QUBO problem and let coupling between qubits correspond to the product of variables in the objective function. A correspondence between the coupling and the product of variables is achieved by making the strength of coupling between i-th qubit and j-th qubit equal to Q_ij of the objective function. Then, by letting all elements of the matrix Q of the objective function correspond to the strength of coupling between qubits in the same manner, the overall energy of qubits corresponds to the objective function of the QUBO problem. Therefore, to solve the QUBO problem by using a quantum annealing machine, it is necessary to input the matrix Q to the quantum annealing machine and adjust the strength of coupling between qubits to be equal to Q_ij. However, coupling between qubits in the quantum annealing machine is not always defined for all combinations of qubits. In fact, coupling between qubits in the quantum annealing machine developed by D-Wave Systems Inc. has the structure of a Chimera graph. Specifically, qubits are at nodes of the Chimera graph, and coupling between qubits corresponds to an edge of the Chimera graph.

As described above, variables in the QUBO problem, qubits, and nodes of a Chimera graph have a correspondence relationship. At the same time, a product of variables in the QUBO problem, coupling between qubits, and an edge of a Chimera graph also have a correspondence relationship. To solve the QUBO problem by using a quantum annealing machine, it is necessary to let variables in the QUBO problem correspond to qubits, which is equivalent to letting variables in the QUBO problem correspond to nodes of a Chimera graph. At the same time, it is necessary to let the product of variables in the QUBO problem correspond to an edge of the Chimera graph so as to let the product of variables in the QUBO problem correspond to coupling between qubits. As described earlier, when solving the QUBO problem by using a quantum annealing machine, variables in the problem are assigned to nodes of the Chimera graph. This assignment needs to be such that the product of variables in the QUBO problem correspond to an edge of the Chimera graph. An appropriate assignment is done when these constraints are satisfied. With this appropriate assignment, it is found to which coupling between qubits on the Chimera graph the product of variables in the QUBO problems needs to correspond. By inputting this assignment and the matrix Q of the QUBO problem to a quantum annealing machine, a correspondence between the strength of coupling between qubits and the matrix Q is achieved. This enables the quantum annealing machine to solve the QUBO problem.

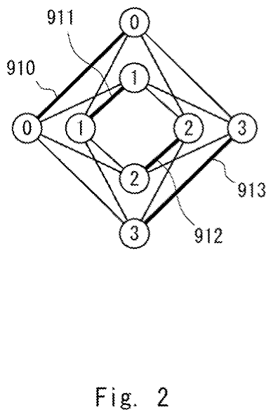

In general, it is necessary to appropriately assign variables to nodes in order to represent the QUBO problem on a Chimera graph as described earlier. One variable may be assigned to a plurality of nodes. To specifically describe what assignment is appropriate, a chain is used. A chain is a set of nodes to which one variable is assigned, i.e., a set of nodes to which the same variable is assigned. Thus, a chain is a group of nodes connected by an edge. A chain may contain one node or a plurality of nodes. When a chain contains a plurality of nodes, every node in the chain needs to be connected by an edge to at least one node in the same chain. FIG. 2 is a schematic view showing an example of a chain. In FIG. 2, a number in each node is a chain number, and nodes with the same number belong to the same chain. FIG. 2 shows four chains: chains 910, 911, 912, and 913.

A constraint for an appropriate assignment needs to be satisfied by every pair of variables appearing as a product in the objective function of the QUBO problem. A constraint for appropriate assignment is that two chains of a pair of variables appearing as a product in the objective function of the QUBO problem are connected by an edge. The condition that chains are connected by an edge is where at least one node in one chain is connected by an edge to at least one node in the other chain. A pair of variables appearing as a product is a pair of x_i and x_j represented by i and j where Q_ij≠0 in the expression (1). When Q_ij=0, it is interpreted that a pair of x_i and x_j do not appear as a product in the objective function. The expression (1), however, is expressed to be inclusive of Q_ij that takes on 0 in order to maintain the generality of representation. When applying the same to the expression (2), it should be noted that the subscripts in the expression (2) and the subscripts in the expression (1) are different, and a pair (i,a) of two subscripts i and a in the expression (2) correspond to i, j and the like in the expression (1). Further, in the expression (2), the product of x_i and x_j with a coefficient of 0 (which is the product of x_i and x_j corresponding to Q_ij=0) is not expressed originally. In the expression (2), whilst x_i,a and x_i,a+1 appear as a product, x_i,a, x_i+1,a+2 do not appear as a product. As a specific example, when a variable that is paired with x_1,1 to appear as a product in the expression (2) is represented as x_j,b, j or b corresponds to any one of the following four cases. A first case is j=1, a second case is b=1, a third case is b=0, and a fourth case is b=2. Variables corresponding to the first case are x_1,0, x_1,1, . . . , x_1,N−2. Variables corresponding to the second case are x_0,1, x_1,1, . . . , x_N−2,1. Variables corresponding to the third case are x_0,0, x_1,0, . . . , x_N−2,0. Variables corresponding to the fourth case are x_0,2, x_1,2, . . . , x_N−1,2. x_1,1 does appear as a product in pair with the other variables. The product corresponding to the first case and the second case (j=1 and b=1) appears by expanding the sum with the coefficient C in the expression (2). The product corresponding to the third case and the fourth case (b=0 and b=2) appears in the first sum in the expression (2).

For example, the chain shown in FIG. 2 gives an appropriate assignment of the objective function of the QUBO problem represented by the following expression (3) to the Chimera graph. The expression (3) involves four variables of the QUBO problem, where a given pair of two variables appear as a product in the objective function. Variable numbers in the expression (3) and chain numbers in FIG. 2 correspond to each other.

$$H = {\sum }_{i , j = 0}^{3} {x}_{i} {x}_{j} \qquad Expression ( 3 )$$

The background of constraints on assignment is as follows. As in the above description based on the assumption of solving the QUBO problem by using quantum annealing machines, it is necessary to let a product of variables in the objective function of the QUBO problem correspond to an edge of a Chimera graph in order to solve the traveling salesman problem. Thus, a constraint for assignment of variables to nodes is, in a naive manner, that nodes to which two variables appearing as a product in the objective function are assigned are connected by an edge. However, since not all pairs of nodes are connected by an edge in a Chimera graph, this is not always achievable. A chain is therefore used.

The same variables in the QUBO problem are assigned to nodes in a chain. Therefore, if chains are connected by an edge, it can be regarded that a product of variables corresponding to those two chains is represented on a Chimera graph. Thus, properly constructing chains allows representing all products of variables in the objective function as edges between chains on the Chimera graph. One example of this method is disclosed in Non Patent Literature 1. The above is the background of the above-described constraints.

When solving a problem using a quantum annealing machine or the like by assigning variables to nodes in a Chimera graph, there is an issue to consider. The issue is that the quantum annealing machine obtains only information of a problem on a Chimera graph and solves this problem, and it does not recognize the original problem before assignment. Stated differently, the quantum annealing machine does not recognize the existence of a chain, and solves the problem where qubits of nodes in the chain are different variables. However, from the viewpoint of those who solve the original QUBO problem, the states of qubits of nodes in the chain need to be all the same. This is because the same variables in the original QUBO problem are assigned to the nodes in the chain. Thus, coupling between qubits corresponding to the edge connecting the nodes in the chain causes a strong interaction, so that all qubits of the nodes in the chain are in the same state. The strength of coupling is specified when solving the problem by the quantum annealing machine.

The fact that the quantum annealing machine solves the problem by treating different nodes in the Chimera graph as different variables means the following also. Specifically, for one QUBO problem, when variables are assigned to a Chimera graph by different assignments, representations of the problem on the Chimera graph obtained by those different assignments are recognized as different problems by the quantum annealing machine. Thus, when there are different assignments, it is necessary to consider which assignment is to be done.

An assignment that satisfies the above-described constraint for a specific problem is generally not unique. Of a plurality of possible assignments, an assignment that uses a small number of nodes is desirable. This is because, when solving a problem by a quantum annealing machine or the like, using more nodes in a Chimera graph causes it to be more difficult to obtain a correct solution. The reason is as follows.

First, when solving the QUBO problem, as the number of variables is greater, the number of combinations increases, which generally makes it more difficult to obtain a correct solution. Put another way, computation time to reliably obtain a correct solution becomes longer. An actual problem to be solved by a quantum annealing machine is a problem represented in a Chimera graph, and the number of variables of the problem to be solved by the quantum annealing machine is the number of nodes used in the Chimera graph. Therefore, as the number of nodes used by assignment is greater, the number of variables in the problem to be solved by the quantum annealing machine increases, which makes it difficult to obtain a correct solution. Even when the original QUBO problem is the same, the difficulty in obtaining a correct solution by using a quantum annealing machine varies by different assignments. Therefore, of a plurality of possible assignments, an assignment that uses a small number of nodes is desirable.

The above-described Non Patent Literature 1 and Non Patent Literature 2 are not designed to find an assignment with a small number of nodes used. It is not easy to find an assignment that satisfies constraints for an appropriate assignment and uses a small number of nodes. In view of the foregoing, an embodiment for obtaining a correspondence between variables of the QUBO problem corresponding to the traveling salesman problem and nodes of a graph for solving the QUBO problem with a small number of nodes used is described in the present disclosure

### <Overview of Embodiment>

Prior to specifically describing an embodiment, the overview is described hereinafter.

The embodiment includes a method of assigning variables in the QUBO problem to nodes in a Chimera graph when representing the traveling salesman problem as the QUBO problem and further representing it on the Chimera graph. In the following description, variables, i.e., binary variables, in the QUBO problem are referred to also as QUBO variables.

This embodiment is designed to construct a chain with a small number of nodes and thereby reduce the total number nodes used when assigning variables in the QUBO problem to a plurality of nodes in a Chimera graph. Policies for constructing a chain with a small number of nodes are as follows.

Variables in the QUBO problem are assigned to a chain. Regarding a pair of variables that appear as a product in the objective function of the QUBO problem, a pair of chains corresponding to this pair of variables need to be connected by an edge in the Chimera graph. In the objective function, a variable appears as a product in pair with another variable, and there are a plurality of variables that can be paired with one variable and appear as a product. For example, in the expression (2), x_1,1 appears as a product in pair with x_1,2 and also in pair with x_2,1. The product of x_1,1 and x_1,2 appears by expanding the first sum and the sum with the coefficient C in the expression (2). The product of x_1,1 and x_2,1 appears by expanding the sum with the coefficient C in the expression (2). Since there are a plurality of variables that can be paired with one variable and appear as a product, a chain needs to be connected to a plurality of different chains by edges. The number of edges from one node on a Chimera graph consisting of K(4) unit cells is six (or five for a node in a unit cell located at the end of the graph). In order for one chain to be connected to six (or five) chains by edges, it is necessary to construct a chain with a plurality of nodes.

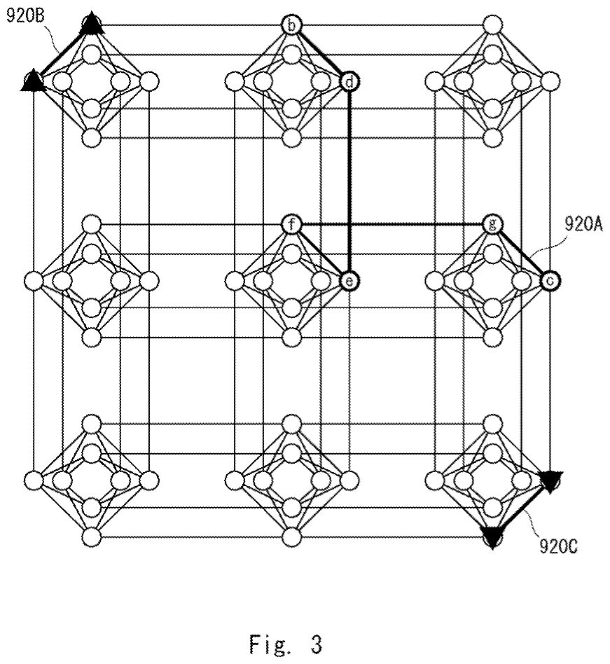

Connection of one chain (which is referred to as A in this example) to a plurality of chains (consider two chains referred to as B and C in this example) by edges is described hereinafter with reference to FIG. 3. In FIG. 3, a chain corresponding to the chain A is denoted by the symbol 920A, a chain corresponding to the chain B is denoted by the symbol 920B, and a chain corresponding to the chain C is denoted by the symbol 920C. In order for the chain A to be connected to the chains B and C by an edge, the chain A needs to contain a node (which is referred to as b) connected to the chain B and a node (which is referred to as c) connected to the chain C by an edge. Since nodes in a chain need to be connected by an edge as described earlier, it is necessary to connect the node b and the node c through edges and nodes in order to let the nodes b and c contained in the chain A. Connecting through edges and nodes means putting a node d connected to the node b through an edge, a node e connected to the node d through an edge, and a node f connected to the node e by an edge into a chain, and finally putting a node g connected to the node c by an edge into the chain. FIG. 3 shows an example of this connection. A plurality of nodes are used in some cases, which increases the number of nodes in the chain. When the nodes (i.e., the above-mentioned nodes d, e, f, g) other than the node b and the node c in the chain A correspond to any of the following two cases, those nodes are contained in the chain A only for the purpose of connecting the node b and the node c. The two cases are where the node is not connected to another chain by an edge and where the node is connected by an edge only to a chain to which a QUBO variable not appearing as a product in the objective function is assigned. The node that applies to any one of those two cases does not directly contribute to the product of variables in the original QUBO problem. Reducing the number of such nodes is a way of constructing a chain with a small number of nodes in this embodiment. Note that, as described earlier, the QUBO variables not appearing as a product in the objective function are generally a pair of x_i and x_j with i and j where Q_ij=0 in the expression (1). When applying the same to the expression (2), it should be noted that the subscripts in the expression (2) and the subscripts in the expression (1) are different, and a pair (i,a) of two subscripts i and a in the expression (2) correspond to i, j and the like in the expression (1). If a variable that does not appear as a product in pair with x_i,a in the expression (2) is represented as x_j,b, j and b do not satisfy any of the following four cases. A first case not satisfied is j=i. A second case not satisfied is b=a. A third case not satisfied is b=a−1. A fourth case not satisfied is b=a+1.

The overview of a method for reducing the number of nodes as described above is described hereinafter. The above-described nodes are the node that is not connected to another chain by an edge and the node that is connected by an edge only to a chain to which QUBO variables not appearing as a product in the objective function are assigned. The method includes four processes.

In the first process, it is determined which nodes are to be contained in the same chain by the same method as Non Patent Literature 1. Variables in the QUBO problem to be assigned to each chain are not determined in this process. This process determines the nodes that form each chain in such a way that all nodes in the chain share the same unit cells as nodes in a specific number (specifically, r−1) of other chains. In the second process, variables are assigned to each chain. This process assigns variables in each chain in such a way that a node (referred to as node a) that satisfies the following constraint comes at the end of the chain. To describe this constraint, consider a chain containing the node a and another chain connected to the node a by an edge. The constraint is that, for every chain connected with the node a by edges, a QUBO variable assigned to this chain and a QUBO variable assigned to the chain to which the node a belongs do not appear as a product in the objective function. In other words, the node a is a node that is not connected with a node to which a variable appearing as a product in pair with a variable assigned to the node a is assigned. In this manner, the node a is a node that is not connected by an edge to a chain to which a binary variable appearing as a product in the objective function of the QUBO problem is assigned. The second process assigns binary variables to a chain in such a way that at least one of the node a is located at the end of the chain. A specific way of assigning variables is described later. A node that is connected by an edge only to a chain corresponding to a QUBO variable not appearing as a product in the objective function does not need to be contained in this chain. Thus, in the third process, a node that satisfies the above constraint is removed from the end of the chain. Specifically, the node a is removed from the end of the chain. Since the chain is not divided into two segments even when the node is removed from the end, an unnecessary node that satisfies the above constraint is can be removed. Of nodes satisfying the above constraint, a node that is not at the end of the chain can not be removed because its removal causes the chain to be disconnected. In the fourth process, the number of such nodes is reduced by changing the position of nodes used. A specific way of changing is described hereinbelow.

Embodiments will be described hereinafter in detail with reference to the drawings.

### First Embodiment

In a first embodiment, an assignment of variables to nodes in the case where the number of nodes included in a unit cell of a Chimera graph is a specified value (specifically, 4) is described.

### [Description of Configuration]

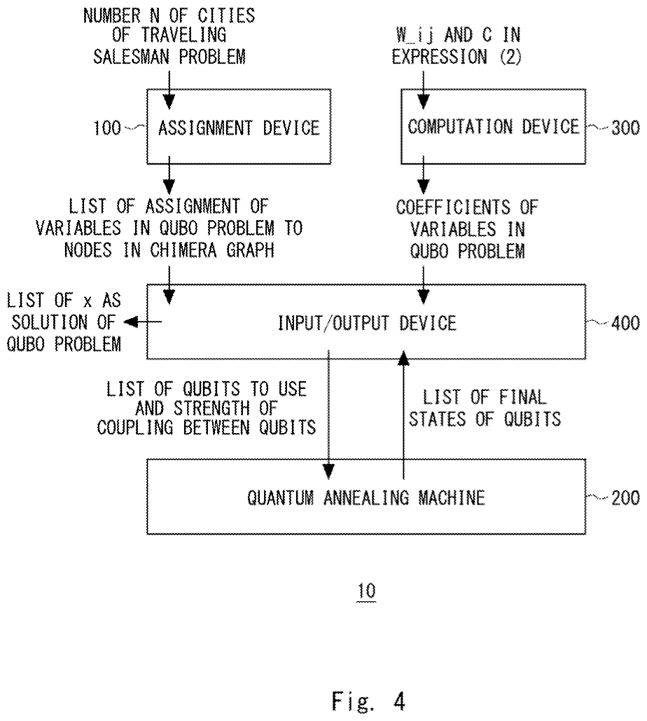

FIG. 4 is a schematic view showing an example of a computation system 10 according to a first embodiment. In this embodiment, a correspondence between variables in the QUBO problem and nodes is determined by an assignment device 100. The computation system 10 shown in FIG. 4 assumes the use of a quantum annealing machine 200 to solve the traveling salesman problem. Note that, instead of the quantum annealing machine 200, another optional device that solves the QUBO problem by using a Chimera graph may be used. Further, the computation system 10 includes a computation device 300 and an input/output device 400 as auxiliary devices for inputting problems to the quantum annealing machine 200 and obtaining output of computation results. In the example shown in FIG. 4, the computation system 10 includes the assignment device 100, the quantum annealing machine 200, the computation device 300, and the input/output device 400.

The assignment device 100 receives as input the number N of cities of the traveling salesman problem, and outputs information indicating a correspondence between variables in the QUBO problem and nodes in the Chimera graph. In this embodiment, the information indicating a correspondence between variables in the QUBO problem and nodes in the Chimera graph is input to the input/output device 400. The information may be input to the input/output device 400 through a user's input operation or directly from the assignment device 100. The computation device 300 is a device that receives as input the distance (W_ij in the expression (2)) between cities in the traveling salesman problem to solve, and outputs coefficients of variables in the QUBO problem. Although the computation device 300 also receives as input the value of C shown in the expression (2) in this embodiment, the computation device 300 may use a specified value as the value of C without receiving this value as input. In this embodiment, coefficients of variables in the QUBO problem calculated by the computation device 300 are input to the input/output device 400. The coefficients may be input to the input/output device 400 through a user's input operation or directly from the computation device 300. The input/output device 400 is a device that performs input and output to and from the quantum annealing machine 200. The input/output device 400 outputs qubits to use and the strength of coupling between qubits to the quantum annealing machine 200 on the basis of output results of the assignment device 100 and the computation device 300. Further, the input/output device 400 acquires the final states of qubits from the quantum annealing machine 200 and outputs a solution of the QUBO problem.

The assignment device 100, the computation device 300, and the input/output device 400 are classical computers, and some or all of the functions of the computation device 300 and the input/output device 400 may be incorporated into the assignment device 100.

Further, some or all of the assignment device 100, the quantum annealing machine 200, the computation device 300, and the input/output device 400 may be implemented using cloud technology. For example, only the quantum annealing machine 200 and the input/output device 400 may be implemented using cloud technology. In the case where only the quantum annealing machine 200 and the input/output device 400 are implemented using cloud technology, output from the assignment device 100 and the computation device 300 may be input to the input/output device 400 through a network. Then, output from the input/output device 400 is input to the quantum annealing machine 200, and output from the quantum annealing machine 200 is input to the input/output device 400. Further, output of computational results from the input/output device 400 is done through a network.

As described earlier, the assignment device 100 receives as input the number of cities of the traveling salesman problem. Then, on the basis of the representation of the objective function (the expression (2)) of the QUBO problem corresponding to the traveling salesman problem, the assignment device 100 outputs information indicating which nodes in the Chimera graph with K(4) unit cells the variables of the objective function are to be assigned to.

Further, the computation device 300 receives as input the distance W between cities in the traveling salesman problem to solve and the parameter C. Input as the value of the parameter C is a specified large value that enables a combination of values of x that minimizes H to be regarded as a solution of the traveling salesman problem. Given this input, the computation device 300 computes and outputs the coefficients of the QUBO variables in the objective function represented by the expression (2). The coefficients of the QUBO variables mean Q_ij when representing the expression (2) by the expression (1). To be specific, the computation device 300 outputs a list of coefficients of variable x_i,a and coefficients of a product of variables x_i,a and x_j,b for i, j=0, 1, 2, . . . , N−2 and a, b=0, 1, 2, . . . , N−2. The computations performed by the computation device 300 are expansion of a quadratic expression of the variables in the QUBO problem, which is easily computable.

Output (assignment results) of the assignment device 100 and output (coefficients of the QUBO variables) of the computation device 300 are input to the input/output device 400. Further, a user specifies the strength (chain strength) of coupling between qubits corresponding to the edge that connects nodes in the chain and inputs the value of the strength to the input/output device 400. Input as the value of the chain strength is a value that causes the qubits of the nodes in the chain to be all in the same state. The chain strength specified here is the same in all chains.

The input/output device 400 determines qubits to use in the quantum annealing machine 200 and calculates the strength of coupling between qubits by using assignment results, the coefficients of the QUBO variables, and the chain strength. The strength of coupling between qubits calculated here includes the strength of coupling corresponding to the edge in the chain, which are all equal to the specified chain strength. The input/output device 400 inputs the list of qubits to use and the strength of coupling between qubits to the quantum annealing machine 200.

The quantum annealing machine 200 actualizes the strength of coupling between qubits specified by input for the qubits specified by input. The quantum annealing machine 200 then performs quantum annealing and outputs a list indicating the final states of qubits to the input/output device 400. The input/output device 400 converts the list indicating the final states of qubits into a list indicating the values of the QUBO variables, and outputs it to an output device (e.g., a display, an electronic file, etc.), which is not shown.

The relationship between the Chimera graph and the quantum annealing machine is as described above. Specifically, coupling between qubits in the quantum annealing machine 200 corresponds to the structure of the Chimera graph. Qubits are in the nodes of the Chimera graph, and coupling between qubits corresponds to the edge of the Chimera graph. A qubit comprises two states, and which state it is in can be treated as a binary variable. This binary variable can be made to correspond to variables in the QUBO problem. By letting the QUBO problem correspond to the Chimera graph and achieving a correspondence between the values of the QUBO variables assigned to the nodes of the Chimera graph and the states of qubits, the quantum annealing machine 200 is able to solve the QUBO problem. Note that, however, when making the QUBO problem correspond to the Chimera graph, it is necessary to appropriately assign variables in the QUBO problem to nodes in the Chimera graph.

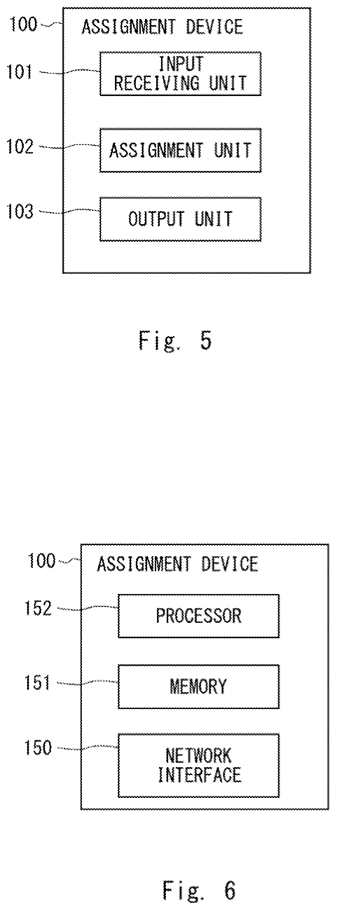

The details of the assignment device 100 are described hereinafter. FIG. 5 is a block diagram showing an example of the functional configuration of the assignment device 100. As shown in FIG. 5, the assignment device 100 includes an input receiving unit 101, an assignment unit 102, and an output unit 103. The input receiving unit 101 receives as input the number N of cities of the traveling salesman problem. This input is done through an input device (not shown) such as a keyboard. For example, a user enters the number N of cities of the traveling salesman problem to solve. The assignment unit 102 performs processing of assigning, to nodes in the Chimera graph, binary variables according to the number N of cities of the traveling salesman problem represented as the QUBO problem. The assignment unit 102 assigns, to nodes connected to each other by an edge in the Chimera graph, a pair of binary variables that appear as a product in the objective function of the QUBO problem in preference to a pair of binary variables that do not appear as a product in the objective function of the QUBO problem. The output unit 103 outputs information indicating a correspondence between binary variables and nodes on the basis of assignment results of binary variables to nodes by the assignment unit 102. The output unit 103 outputs the information to an output device (not shown) such as a display, for example. The output unit 103 outputs a list showing a correspondence between binary variables and nodes, for example. The output unit 103 outputs a list that lists, for i=0, 1, 2, . . . , N−2 and a=0, 1, 2, . . . , N−2, a list of nodes in the Chimera graph to which variables x_i,a are to be assigned, which is a list of lists, for example. In the case of assigning x_0,0 to nodes 0 and 1, x_0,1 to nodes 2 and 3, x_1,0 to nodes 4 and 5, x_1,1 to nodes 6 and 7, the output unit 103 outputs information represented as {x_0,0: [0, 1], x_0,1: [2, 3], x_1,0: [4, 5], x_1,1: [6, 7]}.

FIG. 6 is a block diagram showing an example of the hardware configuration of the assignment device 100. As shown in FIG. 6, the assignment device 100 includes a network interface 150, a memory 151, and a processor 152. The network interface 150, the memory 151, and the processor 152 are connected to one another through a data bus or the like.

The network interface 150 is used to communicate with another optional device. The network interface 150 may include a network interface card (NIC), for example.

The memory 151 consists of a combination of a volatile memory and a nonvolatile memory, for example. The memory 151 is used to store software (computer program) containing one or more instructions, which is executed by the processor 152, data used for various processing of the assignment device 100, and the like.

The processor 152 reads and executes software (computer program) from the memory 151, and thereby performs processing of the elements shown in FIG. 5.

The processor 152 may be a microprocessor, an MPU (Micro Processor Unit), a CPU (Central Processing Unit) or the like. The processor 152 may include a plurality of processors.

In this manner, the assignment device 100 is a device that functions as a computer, which is also called an information processing device.

The above-described program can be stored and provided to a computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

Assignment by the assignment unit 102 is described hereinbelow.

The overview of assignment by the assignment unit 102 is described hereinafter prior to describing its details. The overview is as follows. As described earlier, assignment is based on four processes. However, actual assignment processing of the assignment unit 102 in the assignment device 100 does not go through the four processes. The assignment device 100 previously stores assignment expressions (lookup table) that achieves assignments based on the four processes into the memory 151, for example. There are prepared a plurality of types of assignment expressions corresponding to the number of cities. When the input receiving unit 101 receives the value of the number of cities, the assignment unit 102 performs assignment by referring to the assignment expression corresponding to the received number of cities. Therefore, the four processes are to describe how the assignment expressions stored in the assignment device 100 are determined. Note that the assignment unit 102 may function as a processing unit that performs each of the above-described four processes. Thus, actual assignment processing may go through the four processes.

Consider the case where the Chimera graph has K(4) unit cells. In the first process, it is determined which nodes are to be contained in one chain by the same method as Non Patent Literature 1. To be specific, it is determined which nodes are to be included in the same chain according to the expression (5), which is described later. In this method, all nodes in each chain share the same unit cells as the nodes of the other three chains. In other words, there exist chains A, B, C, and D where a unit cell that includes a node of the chain A always includes nodes of the chains B, C and D. If the overall number of chains is a multiple of 4, the overall chains can be divided into a set of four chains such as the chains A, B, C and D. If, on the other hand, the overall number of chains is not a multiple of 4, there arises one set of chains, which is equal to the remainder of dividing the overall number by 4. A set of four chains is referred to as a bundle hereinbelow. A set of remaining chains, if any, is also referred to as a bundle. The number of chains in one bundle is 4 or less because the Chimera graph in this example is K(4), i.e., r=4. Thus, when a Chimera graph with K(r) unit cells is used, the number of chains in one bundle is r or less.

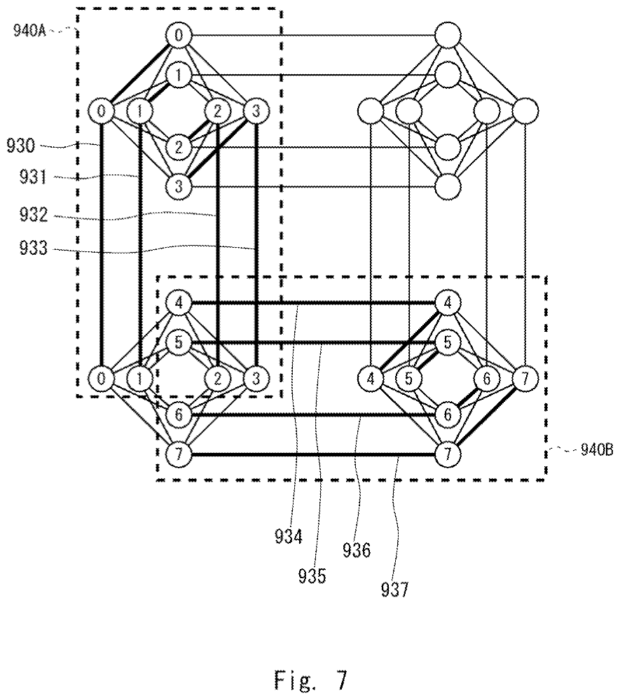

FIG. 7 shows an example of bundles. It shows bundles that are generated in the first process in the case where the number of variables in the QUBO problem is 8. Note that FIG. 7 is a view to help understanding bundles, and in no case the number of variables is 8 when the traveling salesman problem is represented as the QUBO problem. In FIG. 7, a number written in each node represents the number of the chain to which this node belongs. Chains 930, 931, 932 and 933 share unit cells in all nodes, and those chains form a bundle 940A. In the same manner, chains 934, 935, 936 and 937 form a bundle 940B. Thus, in this case, there are two bundles. When one bundle consists of four chains, the number of bundles that can use one unit cell is 2 or less. For example, the lower left unit cell in FIG. 7 is used by two bundles, each of the upper left and the lower right unit cells is used by one bundle, and the upper right unit cell is not used by any bundle.

In the second process, variables are assigned to the chains. The variables x_i,a with the same value of a are assigned to the chain in one bundle. Note that, however, when the number, i.e., N−1, of values which the variable i can take on is 4 or more, the variables are assigned to a plurality of bundles. The number of bundles to which the variables x_i,a with the same value of a are assigned is ceil(N−¼), where ceil(⋅) is a ceiling function. Thus, ceil(y) is the smallest integer of y or more. A specific method of assignment is described later.

In the third process, nodes that are connected by an edge only to a chain corresponding to a QUBO variable not appearing as a product in the objective function are removed, sequentially from the end of the chain. Although a node connected by an edge only to a chain corresponding to a QUBO variable not appearing as a product in the objective function exists also in a position other than the end of the chain, such a node cannot be removed because its removal causes the chain to be divided. Thus, in the fourth process, nodes to be used by the chain are changed to reduce the number of such nodes, and thereby final assignment is determined.

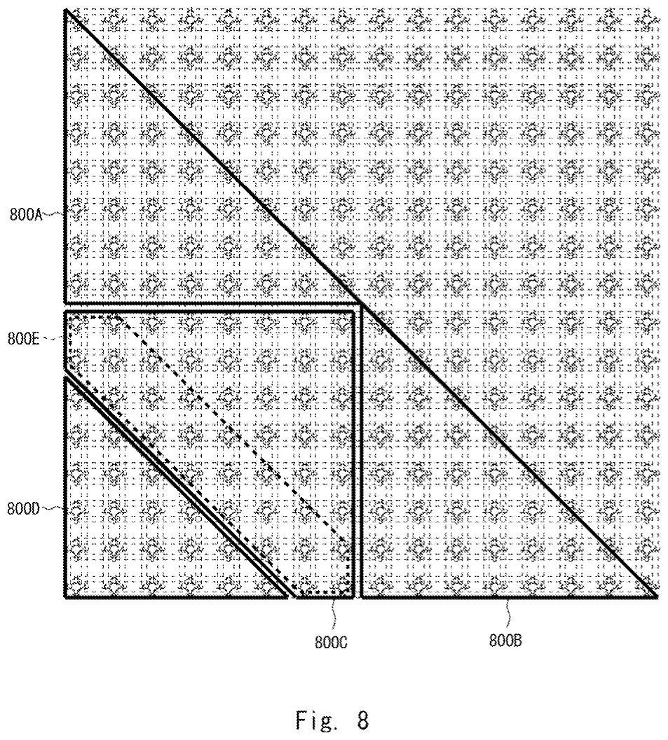

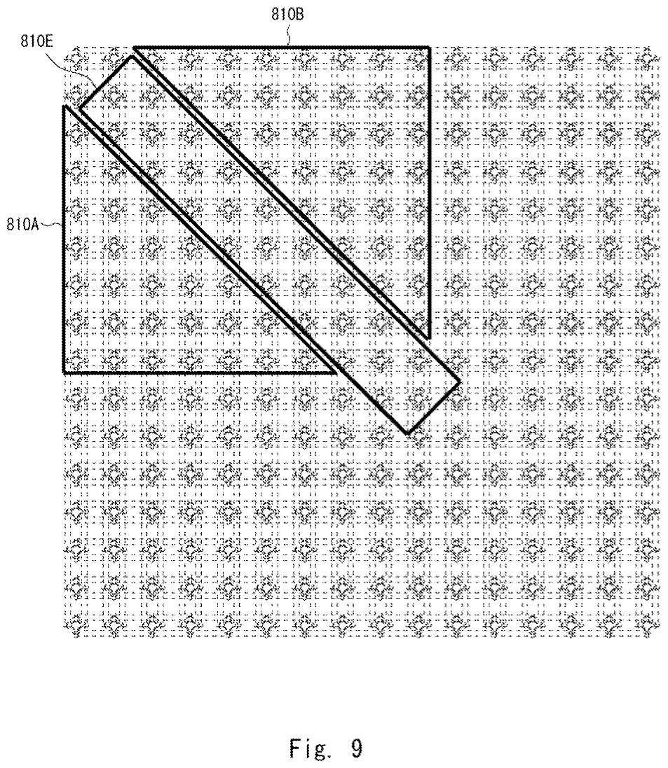

The change of nodes in the fourth process is described hereinafter with reference to FIGS. 8 and 9. FIGS. 8 and 9 show, in blocks, nodes in a Chimera graph to be used in assignments of QUBO variables. FIG. 8 shows an assignment based on Non Patent Literature 1, and FIG. 9 shows an assignment according to this embodiment. The examples shown in FIGS. 8 and 9 assume N=9. In FIG. 8, blocks 800A, 800B, 800C, and 800D are used. A block 800E is a block that is a part of the block 800C. In FIG. 9, blocks 810A, 810B, and 810E are used. The block 810A corresponds to the block 800A, the block 810B corresponds to the block 800B, and the block 810E corresponds to the block 800E. The detailed description about which nodes are included in each block is provided later.

In a change from the state shown in FIG. 8 to the state shown in FIG. 9, the block 800D is removed first. This is performed in the third process to be specific. Next, a change of use of nodes is made so as to use the nodes of the block 810B and the block 810E in FIG. 9 instead of using the nodes of the block 800B and the block 800C in FIG. 8. This allows removing the nodes related to the block 800C, particularly, from nodes to be used. This leads to removing a node that is not at the end of the chain in the assignment shown in FIG. 8, among nodes that are connected by an edge only to a chain corresponding to a QUBO variable not appearing as a product in the objective function, from nodes to be used. However, the change of nodes in this fourth process is made only when N>5. When N≤5, the chain is not long enough to perform this process. When N>5, there are a plurality of bundles consisting of chains to which the variables x_i,a with the same value of a is assigned. In FIG. 8, they are divided into two parts: a bundle included in the block 800A and a bundle included in the block 800B. Likewise, in FIG. 9, they are divided into two parts: a bundle included in the block 810A and a bundle included in the block 810B. Although description of assignments differs depending on the number of bundles included in each part, there is a general rule as described later.

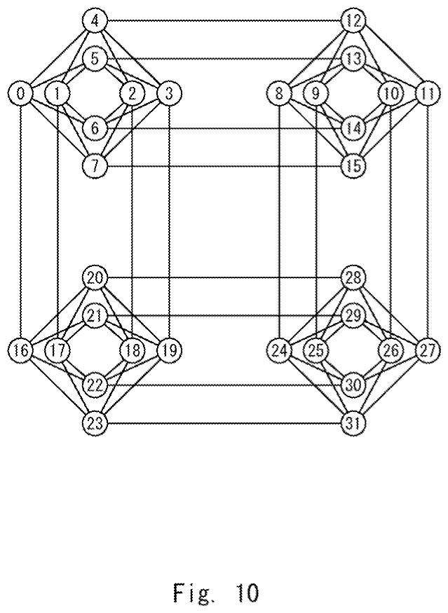

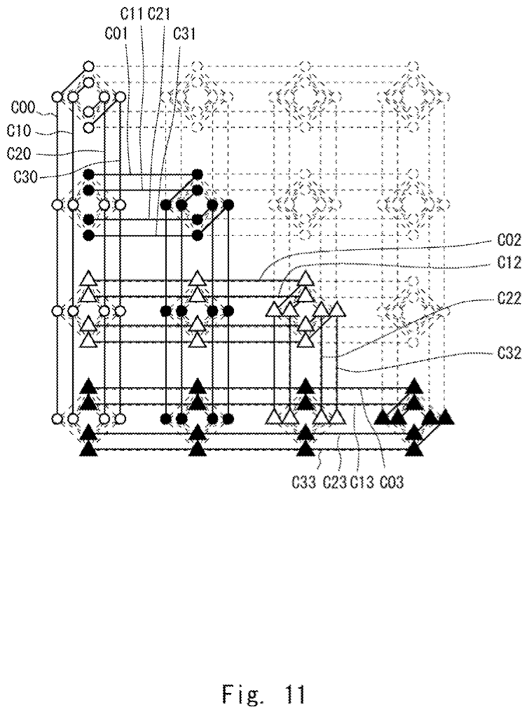

An assignment method is specifically described hereinafter. For specific description of the assignment method, numbers are given to the positions of nodes in the Chimera graph. Let the k-th node of a unit cell in row m and column n be (L×m+n)×8+k. Thus, the numbers of nodes when L=2, for example, are as shown in FIG. 10. In the graph shown in FIG. 10, the numerals written in the nodes are the numbers of the nodes. A function that gives the number of a corresponding node when m, n, and k is defined is f(m, n, k), which is represented by the following expression (4).

f(m,n,k)=(Lm+n)×8+k Expression (4)

In the expression (4), m, n and k are integers of 0 or more. In this embodiment, binary valuables are assigned to a Chimera graph with K(4) unit cells, and therefore k=0, 1, 2, . . . , 7. The upper limit of m and n is L−1. Thus, m, n=0, 1, 2, . . . , L−1. L is any integer greater than N×N/4.

As described earlier, in the first process, it is determined which nodes are to be contained in one chain by the same method as Non Patent Literature 1. Each chain is distinguished by s (s is an integer of 0 or more). Nodes to be contained in the s-th chain are nodes represented by the following expression (5).

f(t,0,u+4),f(t,1,u+4),f(t,2,u+4), . . . ,f(t,t,u+4),f(t,t,u),f(t+1,t,u),f(t+2,t,u), . . . ,f(L−1,t,u) Expression (5)

t and u are uniquely determined by the value of s. t is the greatest integer of s/4 or less. Thus, t=floor(s/4), where floor(⋅) is a floor function. Therefore, floor(y) is the greatest integer of y or less. u is the remainder of dividing s by 4 (u=s−4×floor(s/4)). The relationship s=4×t+u holds true. For example, when s=1, t=0 and u=1, and when s=6, t=1 and u=2. From those relational expressions, each chain is distinguished by the number s, and it is also represented as (t, u). For example, the chain 1 is also represented as the chain (0, 1). The expression (5) is written in the sequence of nodes connected by an edge. Thus, in the expression (5), each node is directly connected by an edge to a node written adjacent to it, and not connected to a node not written adjacent to it. For example, while f(t,1,u+4) is connected by an edge to f(t,0,u+4) and f(t,2,u+4), it is not connected by an edge to the other nodes in the expression (5). Given this relationship, f(t,0,u+4) and f(L−1,t,u) are referred to as the ends of the chain.

In the structure of this chain, only the unit cell in row m and column n that satisfies n≤m≤N−2 is used. There are eight chains that contain the nodes of the unit cell in row m and column n: chains (m, 0), (m, 1), (m, 2), (m, 3), (n, 0), (n, 1), (n, 2), (n, 3). Particularly, the first four chains use four nodes arranged vertically in the unit cell, and the remaining four chains use four nodes arranged horizontally in the unit cell. As is obvious from the structure of the unit cell shown in FIG. 1, each of the former four chains is connected by an edge to each of the latter four chains. For example, the chain (m, 0) is connected by an edge to the chains (n, 0), (n, 1), (n, 2), (n, 3). The former four chains and the latter four chains do not share another unit cell. Thus, the chain (m, h) and the chain (n, v) are connected by an edge only in the unit cell in row m and column n.

The chain (m, h) is connected by an edge to the chain (n, v) in the unit cell in row m and column n, and the nodes where the two chains are connected by an edge are f(m, n, h+4) and f(m, n, v). f(m, n, h+4) is the node that belongs to the chain (m, h), and f(m, n, v) is the node that belongs to the chain (n, v). This is because nodes of the chain (m, h) are those represented as t=m in the expression (5) and, among those nodes, only the node f(m, n, h+4) is included in the unit cell in row m and column n. Likewise, nodes of the chain (n, v) are those represented as t=n in the expression (5) and, among those nodes, only the node f(m, n, v) is included in the unit cell in row m and column n.

In consideration of the sequence of the nodes in the expression (5), as a difference between m and n is greater, the chain (m, h) and the chain (n, v) are more likely to be connected in a node at the end of the chain.

In the second to fourth processes described above, variables in the QUBO problem are assigned to the chains. Description of a method of assignment differs depending on the value of N. The assignment is performed by dividing a bundle into two sets. Thus, the assignment differs significantly depending on the number of bundles for x_i,a with the same value of a. When the number of bundles for x_i,a with the same value of a is 1, the bundle is not divided into two. When the number of bundles for x_i,a with the same value of a is 2, the bundle is divided into two sets, and the number of bundles in each set is 1. When the number of bundles for x_i,a with the same value of a is 3 or 4, the bundle is divided into two sets, and the number of bundles in each set is 1 or 2. Description of assignment differs depending on whether a bundle is divided into sets and the number of bundles in a set with more bundles (which is 2 when the above-described number of bundles is 3).

First, consider the case of N=4, 5, which is when the number (ceil(N−¼)) of bundles for x_i,a with the same value of a is 1. In this case, the variable x_i,a is assigned to the s-th chain that is determined by the relationship of s=4×a+i in the second process. The nodes of the s-th chain are determined in the first process, which are specifically given in the expression (5).

In the third process, nodes f(N−1, a, i), f(N, a, i), f(N+1, a, i), . . . , f(L−1, a, i) are removed from the chain (a, i) corresponding to the variable x_i,a. This is because the chain to which those nodes are connected by an edge does not correspond to any variable of the objective function. For example, whereas the node f(N−1, a, i) is connected by an edge to the chain (N−1, j), the variable x_N−1,j corresponding to this chain (N−1, j) does not exist in the objective function.

In the case of N=4, 5, the fourth process is not performed. This is because, in the chains obtained in the preceding processes, there are no nodes that are connected by an edge only to a chain corresponding to a QUBO variable not appearing as a product in the objective function. Therefore, the assignment determined in the third process is the final assignment.

In order to realize the assignment corresponding to the above processes, in the case of N=4, 5, the assignment unit 102 assigns the variable x_i,a of the QUBO problem in the expression (2) to N number of nodes represented in the following expression (6) for the input N.

x_{i,a}: f(a,a,i),f(a+1,a,i),f(a+2,a,i), . . . ,f(N−2,a,i),f(a,0,i+4),f(a,1,i+4),f(a,2,i+4), . . . ,f(a,a,i+4) Expression (6)

As described earlier, when the number (ceil(N−¼)) of bundles for x_i,a with the same value of a is 1, it means that x_i,a with the same value of a and different values of i are assigned to the nodes in the same unit cell. The unit cell that includes the node represented in the expression (6) is not dependent on i. This is obvious from the fact that m and n of f(m,n,k) specify a unit as the unit cell in row m and column n, and i is not contained in a part corresponding to m and n in the expression (6). Specifically, the unit cell that is used by the bundle corresponding to x_i,a with the same value of a is determined by a, and which node in the unit cell is to be used by the chain in the bundle is determined by i.

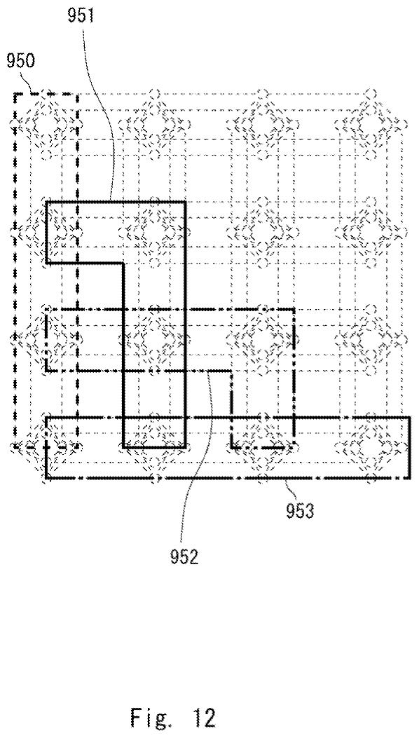

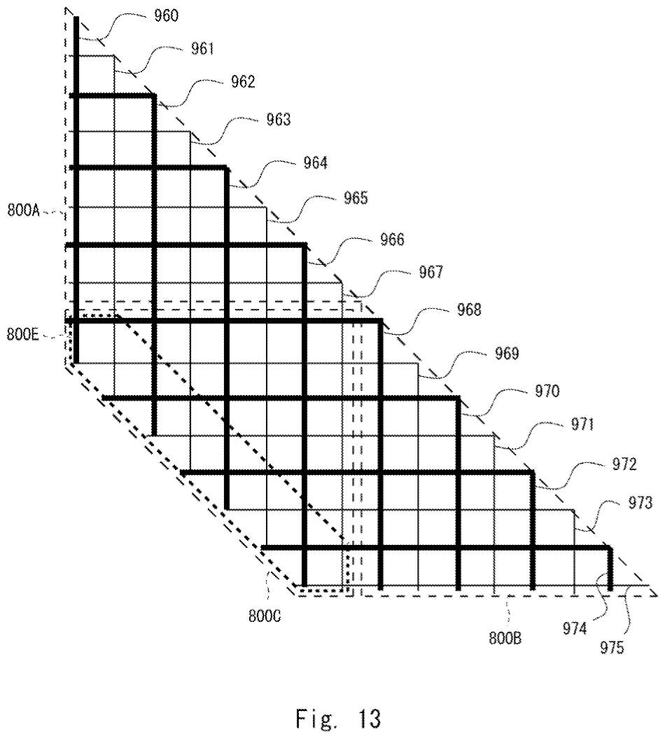

FIG. 11 is a schematic view showing an example of assignment results according to this embodiment, and specifically it shows assignment results when variables of the objective function in the QUBO problem of the traveling salesman problem with N=5 are assigned to nodes in a Chimera graph with K(4) unit cells. In FIG. 11, the symbol of each chain corresponds to the subscripts of the variable x_i,a assigned to this chain. To be specific, the chain C “i” “a” means a chain to which the variable x_i,a is assigned. For example, in FIG. 11, the chain COO is a chain to which the variable x_0,0 is assigned, and the chain C01 is a chain to which the variable x_0,1 is assigned. FIG. 12 shows a group of unit cells used by each bundle in the assignment shown in FIG. 11. In FIG. 12, the bundle 950 corresponds to x_i,0 (where i=0, 1, 2, 3). Likewise, the bundle 951 corresponds to x_i,1 (where i=0, 1, 2, 3), the bundle 952 corresponds to x_i,2 (where i=0, 1, 2, 3), and the bundle 953 corresponds to x_i,3 (where i=0, 1, 2, 3).

As is known from FIGS. 11 and 12, there is a unit cell shared by two different bundles, and in this unit cell, arbitrary chains of the respective bundles are connected by an edge. Specifically, the objective function in which a QUBO variable assigned to the chain of one bundle and an arbitrary QUBO variable assigned to the other bundle appear as a product is represented. There is a unit cell that is shared by such a set of arbitrary two bundles. Thus, the chains belonging to arbitrary different bundles are connected by an edge. Further, in a unit cell that is used only by one bundle, different chains in the bundle are connected by an edge, and therefore the product of the QUBO variables corresponding to those chains in the objective function is represented. The structure of the chain in the unit cell that is used only by one bundle is the same as the structure shown in FIG. 2. As described above, arbitrary two chains are connected by an edge. Use of this assignment allows achieving an appropriate assignment even when any two QUBO variables appear as a product in the objective function of the QUBO problem. An appropriate assignment is thereby achieved also for the objective function of the traveling salesman problem. However, since there is a set of QUBO variables that do not appear as a product in the objective function, an assignment in consideration of such a set is performed in the case of N>5.

Next, consider the case of 6≤N≤9, which is when the number (ceil(N−¼)) of bundles for x_i,a with the same value of a is 2. The assignment device 100 performs different assignments represented by different expressions to two bundles for x_i,a with the same value of a among the variables x_i,a of the QUBO problem in the expression (2) for the input N. x_i,a where i=0, 1, 2, 3 corresponds to one bundle, and x_i,a where i=4, 5, . . . , N−2 corresponds to the other bundle.

In the above-described second process, the variable x_i,a is assigned to the s-th chain determined by the relationship of s=4×a+i for i=0, 1, 2, 3. The nodes of the s-th chain are determined in the first process, which are specifically given in the expression (5). This chain is represented also as the chain (a, i). The variable x_i,a for i=4, . . . , N−2 is assigned to the s-th chain determined by the relationship of s=4×(N−1+a)+i−4. This chain is represented also as the chain ((N−1)+a, i−4).

Nodes that can be removed from the chain, which are nodes that are connected by an edge only to a chain corresponding to a QUBO variable not appearing as a product in the objective function, are concentrated near the end of the chain in the assignment up to this process, and this is described hereinbelow. In this regard, it is important that as a difference between m and n is greater, the chain (m, h) and the chain (n, v) are more likely to be connected in a node at the end of the chain. When a variable that is paired with the variable x_i,a to appear as a product in the objective function is represented as x_j,b, j and b correspond to any one of the following four cases. The first case is j=i, the second case is b=a, the third case is b=a−1, and the fourth case is b=a+1 as described earlier.

First, consider the case of i=0, 1, 2, 3. In the above-described assignment, x_i,a is assigned to the chain (a, i). Further, x_j,b satisfying j=which is the above-described first case, i.e., x_i,b, is assigned to the chain (b, i). When a≥b, the chain (a, i) and the chain (b, i) are connected by an edge only in the unit cell in row a and column b. Thus, the node f(a, b, i+4) of the chain (a, i) to which x_i,a is assigned is connected by an edge to the chain (b, i) to which x_i,b is assigned. In the case of a<b, the chain (a, i) and the chain (b, i) are connected by an edge only in the unit cell in row b and column a. Thus, the node f(b, a, i) of the chain (a, i) to which x_i,a is assigned is connected by an edge to the chain (b, i) to which x_i,b is assigned. Therefore, the chain of x_i,a is connected by an edge to the chain of x_j,b satisfying j=i, which is the chain of x_i,0, x_i,1, . . . , x_i,N−2 in the nodes f(a, 0, i+4), f(a, 1, i+4), . . . , f(a, a, i+4), f(a, a, i), f(a+1, a, i), f(a+2, a, i), . . . , f(N−2, a, i).

Consider a unit cell in which the chain (a, i) to which x_i,a is assigned and the chain to which x_j,b satisfying b=a (the second case), i.e., x_j,a, is assigned are connected by an edge. This differs depending on whether j is any of 0, 1, 2, 3 or any of j=4, 5, . . . , N−2. First, consider the case of j=0, 1, 2, 3. In this case, x_j,a is assigned to the chain (a, j). Then, the chain (a, i) and the chain (a, j) are connected by an edge in the unit cell in row a and column a. The node f(a, a, i) of the chain (a, i) to which x_i,a is assigned is thereby connected by an edge to the chain (a, j). Next, consider the case of j=4, 5, . . . , N−2. In this case, x_j,a is assigned to the chain (N−1+a, j−4). Then, the chain (a, i) and the chain (N−1+a, j−4) are connected by an edge in the unit cell in row (N−1+a) and column a. The node f(N−1+a, a, i) of the chain (a, i) to which x_i,a is assigned is thereby connected by an edge to the chain (N−1+a, j−4).

Likewise, consider the chain (a, i) to which x_i,a is assigned and the chain to which x_j,b satisfying b=a−1 (the third case), i.e., x_j,a−1, is assigned. Those two chains are connected by an edge in the unit cell in row a and column (a−1) or in the unit cell in row (N−2+a) and column a depending on the value of j. The node f(a, a−1, i+4) or the f(N−2+a, a, i) of the chain (a, i) to which x_i,a is assigned is thereby connected by an edge to the chain to which x_j,a−1 is assigned depending on the value of j. Further, the node f(a+1, a, i) or the node f(N+a, a, i) of the chain (a, i) to which x_i,a is assigned is connected by an edge to the chain to which x_j,b satisfying b=a+1 (the fourth case), i.e., x_j,a+1, is assigned.

Given the above, it is determined which nodes are connected by an edge to the chain corresponding to a variable appearing as a product in pair with the variable x_i,a in the objective function in the case of i=0, 1, 2, 3. Those nodes are: f(a, 0, i+4), f(a, 1, i+4), . . . , f(a, a−1, i+4), f(a, a, i+4), f(a, a, i), f(a+1, a, i), f(a+2, a, i), . . . , f(N−2, a, i), f(N−2+a, a, i), f(N−1+a, a, i), f(N+a, a, i). The other nodes are connected by an edge only to a chain corresponding to a QUBO variable not appearing as a product in the objective function. To be specific, the other nodes are: f(N−1, a, i), f(N, a, i), . . . , f(N−3+a, a, i), f(N+a+1, a, i), f(N+a+2, a, i), . . . , f(L−1, a, i). Compared with the expression (5), the nodes f(N+a+1, a, i), f(N+a+2, a, i), . . . , f(L−1, a, i) are concentrated at the end of the chain. As the above-described third process, those nodes are removed from the chain. Note that, however, the nodes f(N−1, a, i), f(N, a, i), . . . , f(N−3+a, a, i) cannot be removed because they serve as connecting the chain into one.

Next, consider the case of i=4, 5, 6, . . . , N−2. In the above-described assignment, x_i,a is assigned to the chain (N−1+a, i−4). Further, x_j,b satisfying j=i (the first case), i.e., x_i,b, is assigned to the chain (N−1+b, i−4). In this case, the chain of x_i,a is connected by an edge to the chain of x_j,b satisfying j=i, which is the chain of x_i,0, x_i,1, . . . , x_i,N−2 in the nodes f(N−1+a, N−1, i), f(N−1+a, N, i), . . . , f(N−1+a, N−1+a, i), f(N−1+a, N−1+a, i−4), f(N+a, N−1+a, i−4), f(N+a+1, N−1+a, i−4), . . . , f(2N−3, N−1+a, i−4).

Consider the chain to which x_j,b satisfying b=a (the second case), i.e., x_j,a, is assigned. In the case of j=0, 1, 2, 3, the node f(N−1+a, a, i) of the chain (N−1+a, i−4) of x_i,a is connected by an edge to the chain (a, j) of x_j,a in the unit cell in row (N−1+a) and column a. In the case of j=4, 5, . . . , N−2, the node f(N−1+a, N−1+a, i) of the chain (N−1+a, i−4) of x_i,a is connected by an edge to the chain (N−1+a, j−4) of x_j,a in the unit cell in row (N−1+a) and column (N−1+a).

Likewise, consider x_j,b satisfying b=a−1 (the third case), i.e., x_j,a−1. The chain of x_i,a and the chain of x_j,a−1 are connected by an edge in the unit cell in row (N−1+a) and column (a−1) or in the unit cell in row (N−1+a) and column (N−2+a) depending on the value of j. The node f(N−1+a, a−1, i) or the node f(N−1+a, N−2+a, i) of the chain (N−1+a, i−4) of x_i,a is thereby connected by an edge to the chain of x_j,a−1. Further, the node f(N−1+a, a+1, i) or the node f(N+a, N−1+a, i−4) of the chain (N−1+a, i) of x_i,a is connected by an edge to the chain of x_j,b satisfying b=a+1 (the fourth case), i.e., x_j,a+1.

Given the above, it is determined which nodes are connected by an edge to the chain corresponding to a variable appearing as a product in pair with the variable x_i,a in the objective function in the case of i=4, 5, . . . , N−2. Those nodes are: f(N−1+a, a−1, i), f(N−1+a, a, i), f(N−1+a, a+1, i), f(N−1+a, N−1, i), f(N−1+a, N, i), . . . , f(N−1+a, N−1+a, i), f(N−1+a, N−1+a, i−4), f(N+a, N−1+a, i−4), f(N+a+1, N−1+a, i−4), . . . , f(2N−3, N−1+a, i−4). The other nodes are connected by an edge only to a chain corresponding to a QUBO variable not appearing as a product in the objective function. To be specific, the other nodes are: f(N−1+a, 0, i), f(N−1+a, 1, i), . . . , f(N−1+a, a−2, i), f(N−1+a, a+2, i), f(N−1+a, a+3, i), . . . , f(N−1+a, N−2, i), f(2N−2, N−1+a, i−4), f(2N−1, N−1+a, i−4), . . . , f(L−1, N−1+a, i−4). Compared with the expression (5), the nodes f(N−1+a, 0, i), f(N−1+a, 1, i), . . . , f(N−1+a, a−2, i) are concentrated at the end of the chain. Further, the nodes f(2N−2, N−1+a, i−4), f(2N−1, N−1+a, i−4), . . . , f(L−1, N−1+a, i−4) are also concentrated at the end of the chain. As the above-described third process, those nodes are removed from the chain. Note that, however, the nodes f(N−1+a, a+2, i), f(N−1+a, a+3, i), . . . , f(N−1+a, N−2, i) cannot be removed because they serve as connecting the chain into one.

The above-described fourth process is described hereinafter. The blocks of the Chimera graph shown in FIG. 8 are used in the following description. FIG. 8 shows the blocks in the case of N=9. Generally, the block 800A is composed of the nodes used only by the chain of x_i,a where i=0, 1, 2, 3, and the block 800B consists of the nodes used only by the chain of x_i,a where i=4, 5, . . . , N−2. The block 800C consists of the remaining nodes used by the chain. The block 800D is a part removed in the third process.

In the fourth process, nodes that serve only as connecting a chain into one are removed from the chain. For example, in the case of i=0, 1, 2, 3, the nodes f(N−1, a, i), f(N, a, i), . . . , f(N−3+a, a, i) serve only as connecting the chain into one and are not directly involved in the product of QUBO variables of the objective function. However, those nodes are needed to connect the chain into one and therefore cannot be removed. Such nodes are located in the block 800C. On the other hand, the nodes that directly contribute to the product of QUBO variables of the objective function in the block 800C are located in unit cells in row (N−2+a) and column a, in row (N−1+a) and column a, and in row (N+a) and column a where a=0, 1, . . . , N−2. Those are unit cells in the block 800E, which is a part surrounded by a dotted line in the block 800C in FIG. 8. The two oblique lines of the block 800E are parallel to the oblique lines of the block 800A and the block 800B. Thus, if the block 800E is placed in such a way that those two oblique lines are in contact with the oblique lines of the block 800A and the block 800B, the remaining part of the block 800C (the part with the nodes not directly involved in the product of QUBO variables of the objective function) are no longer needed and can be removed.

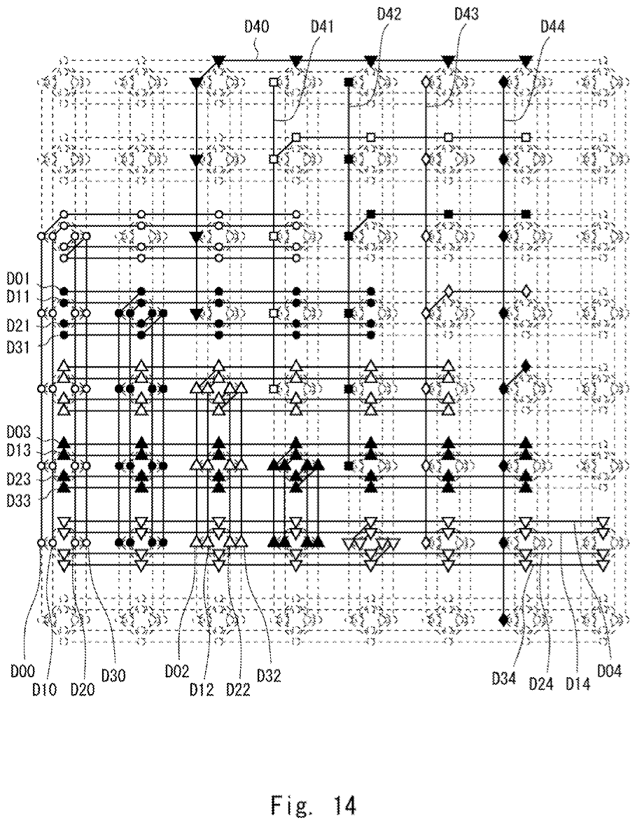

To help understanding the fourth process, the placement of bundles at the end of the third process is described below. FIG. 13 is a schematic view showing the placement of bundles at the end of the third process. In the case of N=9, there are 16 bundles 960, 961, 962, 963, 964, 965, 966, 967, 968, 969, 970, 971, 972, 973, 974, 975. The bundle 960 uses the unit cells from row 0 and column 0 to row 0 and column 9 arranged in the vertical direction (in the column direction). The bundle 961 uses the unit cells from row 1 and column 0 to row 1 and column 1 arranged in the horizontal direction (in the row direction) and the unit cells from row 1 and column 1 to row 1 and column 10 arranged in the vertical direction (in the column direction). Likewise, the bundle 962 uses the unit cells from row 2 and column 0 to row 2 and column 2 arranged in the horizontal direction (in the row direction) and the unit cells from row 2 and column 2 to row 2 and column 11 arranged in the vertical direction (in the column direction). In this manner, at the end of the third process, each bundle uses the following group of unit cells among the nodes of the block 800A, the block 800B and the block 800C. Each bundle uses a group of unit cells (only unit cells with the column number of z or less) that are in line with the unit cell in row z and column z (where z is an integer of 0 or more) in the row direction and a group of unit cells (only unit cells with the row number of z or more) that are in line with the unit cell in row z and column z in the column direction.

In FIG. 13, if the unit cells in the block 800C outside the part of the block 800E are not used, the chains included in the bundles using those unit cells are disconnected. Specifically, the chains are divided into chain segments belonging to the block 800A and chain segments belonging to the block 800E. Alternatively, the chains are divided into chain segments belonging to the block 800B and chain segments belonging to the block 800E. Therefore, in the fourth process, nodes to use are changed in such a way that a first chain segment and a second chain segment connected through an unnecessary node are connected not through the unnecessary node. Specifically, the nodes that form the chain in the Chimera graph are changed so as to connect, not through the unnecessary node, the first chain segment and the second chain segment of the chain where those two chain segments are connected through the unnecessary node. After that, this unnecessary node is removed from this chain, and thereby the final assignment of binary variables to nodes is determined. The first chain segment belongs to the block 800A or the block 800B, and the second chain segment belongs to the block 800E. Further, the unnecessary node is a node that is not connected by an edge to the chain to which a binary variable appearing as a product in the objective function of the QUBO problem is assigned. To make this change, the block 800B is shifted in such a way that the block 800C (block 800E) is placed between the block 800A and the block 800B, which is the state shown in FIG. 9.

In this shift of blocks, the block 800A is shifted by two unit cells in the direction of increasing the row number along the column direction (vertical direction). As a result, the block 810A in FIG. 9 is used instead of the block 800A in FIG. 8. This is to provide space for placing the block 810B (block 800B) and the block 810E (block 800E). Further, when the block 800B is changed to the block 810B, it is shifted in parallel and also rotated. As a result, the block 810B in FIG. 9 is used instead of the block 800B in FIG. 8. The nodes used by the chain of the variable x_i,a (where i=4, 5, . . . , N−2) are thereby changed. If the variable x_i,a uses the node f(m, n, k) in the block 800B before shift, it uses the node f(n−(N−1), m−(N−3), k′) instead after shift, where k′=k+4 when k<4 and k′=k−4 when k≥4. Changing between n and m and between k and k′ represents rotation, and subtracting (N−1) or (N−3) means parallel shift. Particularly, changing between k and k′ in rotation represents changing between nodes to use in a unit cell. Specifically, when using one of four nodes arranged horizontally (vertically) in a unit cell before shift, one of four nodes arranged vertically (horizontally) in a unit cell is used after shift. While the variable x_i,a uses f(N−1+a, N−1, i), f(N−1+a, N, i), . . . , f(N−1+a, N−1+a, i), f(N−1+a, N−1+a, i−4), f(N+a, N−1+a, i−4), f(N+a+1, N−1+a, i−4), . . . , f(2N−3, N−1+a, i−4) before shift, it uses f(0, a+2, i−4), f(1, a+2, i−4), . . . , f(a, a+2, i−4), f(a, a+2, i), f(a, a+3, i), . . . , f(a, N, i) after shift.

Further, the nodes used in the block 800E by the chain of x_i,a are also changed by shift. As a result, the block 810E in FIG. 9 is used instead of the block 800E in FIG. 8. If f(m, n, k) is used before shift, f(n+2, m−(N−3), k′) is used after shift, where k′=k+4 when k<4 and k′=k−4 when k≥4. To be specific, while the variable x_i,a uses f(N−2+a, a, i), f(N−1+a, a, i), f(N+a, a, i) before shift, it uses f(a+2, a+1, i+4), f(a+2, a+2, i+4), f(a+2, a+3, i+4) after shift. The nodes of the remaining part of the block 800C are removed from the chain.

By the above-described four processes, the final assignment performed by the assignment unit 102 of the assignment device 100 is obtained.

When 6≤N≤9, the assignment unit 102 of the assignment device 100 assigns the variables x_i,a with i=0, 1, 2, 3 to the (N+3) number of nodes represented in the expression (7), and assigns the variables x_i,a with i=4, 5, . . . , N−2 to the (N+3) number of nodes represented in the expression (8).

x_{i,a}: f(a+2,a,i),f(a+3,a,i),f(a+4,a,i), . . . ,f(N,a,i),f(a+2,0,i+4),f(a+2,1,i+4),f(a+2,2,i+4), . . . ,f(a+2,a+3,i+4) Expression (7)

The assignment of the expression (7) is such that m in f(m,n,k) is increased by 2 and three nodes f(a+2, a+1, i+4), f(a+2, a+2, i+4), f(a+2, a+3, i+4) are added in the assignment of the expression (6) where N=4, 5. In the assignment of the expression (7), the unit cells to use are shifted by two units in the vertical direction from the assignment of the expression (6) and then three nodes to use are added thereto. The added nodes correspond to the nodes of the block 810E in FIG. 9.

x_{i,a}: f(0,a+2,i−4),f(1,a+2,i−4),f(2,a+2,i−4), . . . ,f(a+3,a+2,i−4),f(a,a+2,i),f(a,a+3,i),f(a,a+4,i), . . . ,f(a,N,i) Expression (8)

When the nodes used in the assignment of the expression (7) are f(m,n,k), the nodes used in the expression (8) are f(n, m, k′), where k′=k+4 when k<4 and k′=k−4 when k≥4. Changing between m and n represents changing between a row and a column in a unit cell used, and changing between k and k′ represents changing of nodes used in the unit cell. When using one of four nodes arranged horizontally (vertically) in the unit cell in the expression (7), one of four nodes arranged vertically (horizontally) in the unit cell is used in the expression (8). It should be noted that i=0, 1, 2, 3 in the expression (7) and i=4, 5, . . . , N−2 in the expression (8).

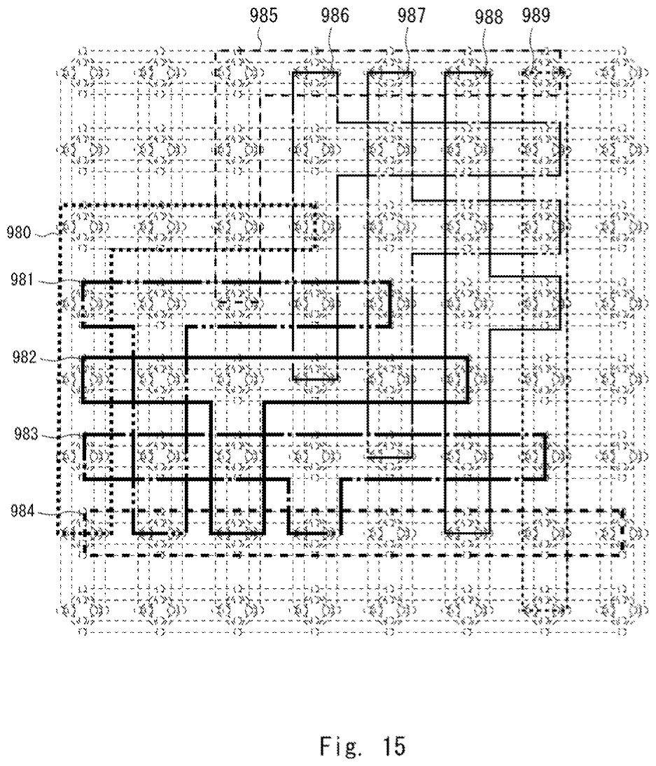

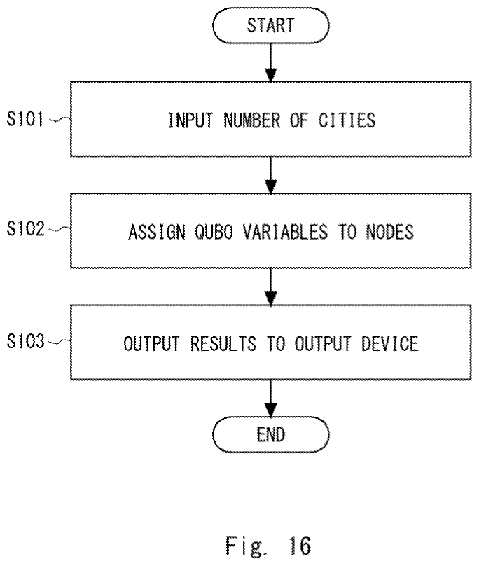

FIG. 14 is a schematic view showing assignment results at N=6 in this embodiment. Specifically, FIG. 14 shows assignment results when variables of the objective function in the QUBO problem of the traveling salesman problem with N=6 are assigned to nodes in the Chimera graph with K(4) unit cells. In FIG. 14, the symbol of each chain corresponds to the subscripts of the variable x_i,a assigned to this chain. To be specific, the chain D “i” “a” means a chain to which the variable x_i,a is assigned. For example, in FIG. 14, the chain D00 is a chain to which the variable x_0,0 is assigned, and the chain D01 is a chain to which the variable x_0,1 is assigned. FIG. 15 shows a group of unit cells used by each bundle in the assignment shown in FIG. 14. In FIG. 15, the bundle 980 corresponds to x_i,0 (where i=0,1, 2, 3). Likewise, the bundle 981 corresponds to x_i,1 (where i=0, 1, 2, 3). The bundle 982 corresponds to x_i,2 (where i=0, 1, 2, 3). The bundle 983 corresponds to x_i,3 (where i=0, 1, 2, 3). The bundle 984 corresponds to x_i,4 (where i=0, 1, 2, 3). The bundle 985 corresponds to x_4,0. The bundle 986 corresponds to x_4,1. The bundle 987 corresponds to x_4,2. The bundle 988 corresponds to x_4,3. The bundle 989 corresponds to x_4,4.

Next, consider the case of N>9. The assignment in this embodiment is performed by dividing a bundle into two sets, and the maximum value (which is represented as p) of the number of bundles in each set for x_i,a with the same value of a affects the assignment. When N is greater than 9, the number (ceil(N−¼)) of bundles for x_i,a with the same value of a is greater than 2. Thus, when a bundle for x_i,a with the same value of a is divided into two sets, the number of bundles is greater than 1 in one set. The assignment expression is thereby different from that in the case of N≤9. To generalize this, the assignment expression is represented by using p. p for a specific value of N satisfies 8 (p−1)+2≤N≤8×p+1. For example, when N=9, the number ceil(N−¼) of bundles for x_i,a with the same value of a is 2, and p=1. When N=10, the number ceil(N−¼) of bundles for x_i,a with the same value of a is 3, and p=2. When N=17, the number ceil(N−¼) of bundles for x_i,a with the same value of a is 4, and p=2. Further, when 10≤N≤17, p=2. When N=18, p=3.

To consider the case of N>9, let p be an integer of 2 or more. In the second process, the variables x_i,a with i=0, 1, 2, . . . , 4p−1 are assigned to the s-th chain that is determined by the relationship of s=4×p×a+i. Further, the variables x_i,a with i=4p, 4p+1, . . . , N−2 are assigned to the s-th chain that is determined by the relationship of s=4p×(N−1+a)+i−4p. The nodes of the s-th chain are determined in the first process, which are specifically given in the expression (5).

As in the case of p=1, nodes that can be removed from the chain are concentrated near the end of the chain in the assignment up to this process, and those nodes are removed from the chain in the third process. Specifically, the following nodes are removed. In the case of i=0, 1, 2, . . . , 4p−1, the nodes that are located at the end of the chain corresponding to the variable x_i,a and can be removed are f(p(N+a+1), pa+i//4, i %4), f(p(N+a+1)+1, pa+i//4, i %4), . . . , f(L−1, pa+i//4, i %4), where i//y represents an integer part (e.g., 3//4=0, 4//4=5//4=1) when dividing i by y, and i % y represents the remainder (e.g., 3%4=3, 4%4=0, 5%4=1) when dividing i by y. In the case of i=4p, 4p+1, . . . , N−2, the nodes that are located at the end of the chain and can be removed are f(p(N−1+a)+i//4−p, 0, i %4+4), f(p(N−1+a)+i//4−p, 1, i %4+4), . . . , f(p(N−1+a)+i//4−p, p(a−1)−1, i %4+4) and f(p(2N−2), p(N−1+a)+i//4−p, i %4), f(p(2N−2)+1, p(N−1+a)+i//4−p, i %4), . . . , f(L−1, p(N−1+a)+i//4−p, i %4).

In the fourth process also, blocks are taken into consideration as in the case of p=1. The block 800A consists of the nodes used only by the chain of x_i,a where i=0, 1, . . . , 4p−1, and the block 800B consists of the nodes used only by the chain of x_i,a where i=4p, 4p+1, . . . , N−2. The block 800C consists of the remaining nodes used by the chain.

The nodes that directly contribute to the product of QUBO variables of the objective function in the block 800C, which are the nodes that belong to the block 800E, are located in unit cells in row q(N−2+a) and column qa, in row q(N−1+a) and column qa, and in row q(N+a) and column qa where a=0, 1, . . . , N−2 and q=1, 2, . . . , p. As in the case of p=1, the block 800E has two oblique lines, and the two oblique lines are parallel to the oblique lines of the block 800A and the block 800B. The block 800B is shifted in such a way that the block 800C (block 800E) is placed between the block 800A and the block 800B, and the two oblique lines of the block 800E are in contact with the oblique lines of the block 800A and the block 800B. The remaining part of the block 800C (the part with the nodes not directly involved in the product of QUBO variables of the objective function) are removed.

In this shift of blocks, the block 800A is shifted by 2p unit cells in the direction of increasing the row number along the column direction (vertical direction). As a result, the block 810A in FIG. 9 is used instead of the block 800A in FIG. 8. Further, when the block 800B is changed to the block 810B, it is shifted in parallel and also rotated. As a result, the block 810B in FIG. 9 is used instead of the block 800B in FIG. 8. The nodes used by the chain of the variable x_i,a (where i=4p, 4p+1, . . . , N−2) are thereby changed. If the variable x_i,a uses the node f(m, n, k) in the block 800B before shift, it uses the node f(n−p(N−1), m−p(N−3), k′) instead after shift, where k′=k+4 when k<4 and k′=k−4 when k≥4. While the variable x_i,a uses f(p(N−1+a)+i//4−p, p(N−1), i %4+4), f(p(N−1+a)+i//4−p, N, i %4+4), . . . , f(p(N−1+a)+i//4−p, p(N−1+a)+i//4−p, i %4+4), f(p(N−1+a)+i//4−p, p(N−1+a)+i//4−p, i %4), f(p(N−1+a)+i//4−p+1, p(N−1+a)+i//4−p, i %4), f(p(N−1+a)+i//4−p+2, p(N−1+a)+i//4−p, i %4), . . . , f(p(2N−2)−1, p(N−1+a)+i//4−p, i %4) of the block 800B before shift, it uses f(0, p(a+2)+i//4−p, i %4), f(1, p(a+2)+i//4−p i %4), . . . , f(pa+i//4−p, p(a+2)+i//4−p, i %4), f(pa+i//4−p, p(a+2)+i//4−p, i %4+4), f(pa+i//4−p, p(a+2)+i//4−p+1, i %4+4), . . . , f(pa+i//4−p, p(N+1)−1, i %4+4) after shift, where // and % represent the meaning described above.

The nodes used in the block 800E by the chain of x_i,a are also changed by shift. As a result, the block 810E in FIG. 9 is used instead of the block 800E in FIG. 8. If f(m, n, k) is used before shift, f(n+2p, m−p(N−3), k′) is used after shift, where k′=k+4 when k<4 and k′=k−4 when k≥4. For example, in the case of i=0, 1, . . . , 4p−1, while the variable x_i,a uses f(p(N−2+a)+i//4, pa+i//4, i %4), f(p(N−2+a)+i//4+1, pa+i//4, i %4), . . . , f(p(N+a+1)−1, pa+i//4, i %4) before shift, it uses f(p(a+2)+i//4, p(a+1)+i//4, i %4+4), f(p(a+2)+i//4, p(a+1)+i//4+1, i %4+4), f(p(a+2)+i//4, p(a+1)+i//4+2, i %4+4), . . . , f(p(a+2)+i//4, p(a+4)−1, i %4+4) after shift. The nodes of the remaining part of the block 800C are removed from the chain.

By the above-described four processes, the final assignment performed by the assignment unit 102 of the assignment device 100 is obtained.

In the case of N>9, the assignment unit 102 of the assignment device 100 assigns the variables x_i,a with i=0, 1, 2, 3 of the QUBO problem in the expression (2) to p (N+3) number of nodes represented by the expression (9) for the input N. Further, the assignment unit 102 assigns the variables x_i,a with i=4p, 4p+1, 4p+2, 4p+3 to p (N+3) number of nodes represented by the expression (10).

x_{i,a}: f(pa+2p,pa,i),f(pa+2p+1,pa,i), . . . ,f(p(N+1)−1,pa,i),f(pa+2p,0,i+4),f(pa+2p,1,i+4), . . . ,f(pa+2p,pa+4p−1,i+4) Expression (9)

The assignment of the expression (9) is an extension of the expression (7) in the case of 6≤N≤9. The number of nodes used is p-times greater than that of the expression (7). With regard to the position f(pa+2p, pa, i) of the node written first, each time a is incremented by 1, the unit cell used is shifted by p in the vertical direction and in the horizontal direction. In the unit cells placed therein, there are (p−1) number of other bundles for the variable x_i,a with the same value of a.

x_{i,a}: f(0,pa+2p,i−4p),f(1,pa+2p,i−4p), . . . ,f(pa+4p−1,pa+2p,i−4p),f(pa,pa+2,i−4(p−1)),f(pa,pa+2p+1,i−4(p−1)), . . . ,f(pa,p(N+1)−1,i−4(p−1) Expression (10)

When the nodes used in the assignment of the expression (9) are f(m,n,k), the nodes used in the expression (10) are f(n, m, k′), where k′=k+4 when k<4 and k′=k−4 when k≥4. Changing between m and n represents changing between a row and a column in a unit cell used, and changing between k and k′ represents changing of nodes used in the unit cell. When using one of four nodes arranged horizontally (vertically) in the unit cell in the expression (9), one of four nodes arranged vertically (horizontally) in the unit cell is used in the expression (10). It should be noted that i=0, 1, 2, 3 in the expression (9) and i=4p, 4p+1, 4p+2, 4p+3 in the expression (10).

The case where p is an integer of 2 or more is considered above, and the expression (9) coincides with the expression (7), and the expression (10) coincides with the expression (8) when p=1. In the case of p=1, the entire assignment is completed by the expression (7) and the expression (8); however, in the case of p≥2, there are variables x_i,a with i other than i=0, 1, 2, 3, 4p, 4p+1, 4p+2, 4p+3 assigned by the expression (9) and the expression (10), which are not yet assigned. This results from that the number of bundles is 3 or more. Using an integer q satisfying 1≤q<p, i of the unassigned variables x_i,a is represented by i=4q, 4q+1, 4q+2, 4q+3, 4(p+q), 4(p+q)+1, 4(p+q)+2, 4(p+q)+3.

The variables x_i,a with i=4q, 4q+1, 4q+2, 4q+3 (1≤q<p) are assigned to the nodes sequentially in ascending order of the value of q. Consider first x_i,a (i=4, 5, 6, 7) with q=1. Consider therefore the nodes to which x_i−4,a is assigned. i−4=0, 1, 2, 3, and x_i−4,a is already assigned to the node by the expression (9). Starting from the nodes to which x_i−4,a is assigned, the nodes are shifted in parallel by +1 in row and +1 in column of the unit cell. Specifically, if one of the nodes to which x_i−4,a is assigned is f(m, n, k), it is shifted to f(m+1, n+1, k). x_i,a is then assigned to the node at the position after it is shifted in parallel in this way. Since there are p(N+3) number of nodes to which x_i−4,a is assigned, x_i,a is assigned to the nodes that are shifted in parallel in the same manner. Note that, however, x_i,a is not assigned to the node of f(p(N+1), pa+q, i−4q). Alternatively, x_i,a is assigned to f(pa+2p+q, pa+q, i−4(q−1)). Consider next x_i,a (i=8, 9, 10, 11) corresponding to q=2. In the same manner as above, x_i,a is assigned to nodes at positions after they are shifted in parallel by +1 in row and +1 in column of the unit cell from the node to which x_i−4,a (i−4=4, 5, 6, 7) is assigned. Note that, however, x_i,a is not assigned to the node of f(p(N+1), pa+q, i−4q). Alternatively, x_i,a is assigned to f(pa+2p+q, pa+q, i−4(q−1)). The same assignment is performed up to q=p, with q incremented by 1 each time.

After that, x_i,a with i=4(p+q), 4(p+q)+1, 4(p+q)+2, 4(p+q)+3 (1≤q<p) are assigned to nodes. Consider q=1 first. In the same manner as above, x_i,a is assigned to nodes at the positions after they are shifted in parallel by +1 in row and +1 in column of the unit cells from the positions of the nodes to which x_i−4,a is assigned. Note that, however, x_i,a is not assigned to the node of f(pa+q, p(N+1), i−4(p+q−1)). Alternatively, x_i,a is assigned to f(pa+q, pa+2p+q, i−4(p+q)). Then, x_i,a corresponding to q=2 is assigned. The same assignment is performed up to q=p, with q incremented by 1 each time. As described above, the assignment unit 102 of the assignment device 100 assigns all variables x_i,a to nodes.

### [Description of Operation]

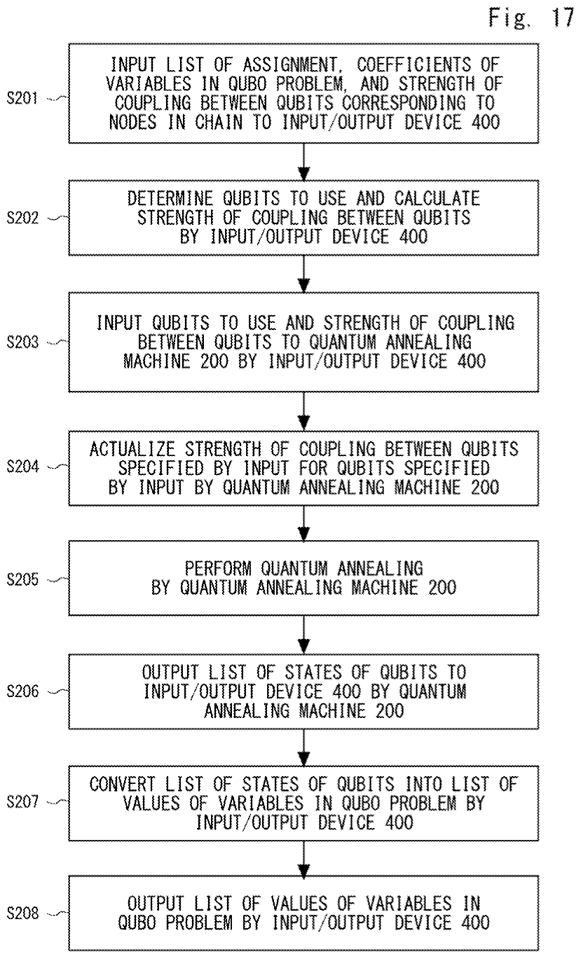

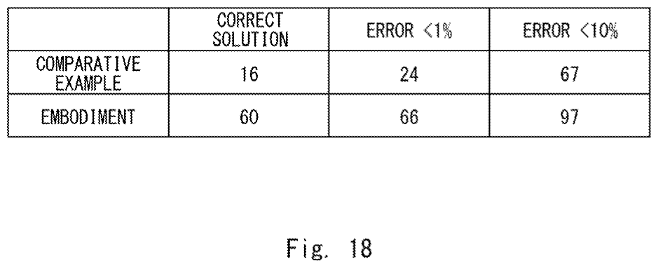

The operation of this embodiment is described hereinafter with reference to the drawings. FIG. 16 is a flowchart showing the flow of the operation of the assignment device 100. FIG. 17 is a flowchart showing the flow of the computation of the traveling salesman problem (QUBO problem) by the computation system 10.

The flow of the operation of the assignment device 100 is described hereinafter with reference to FIG. 16.

First, the input receiving unit 101 of the assignment device 100 receives as input the number N of cities of the traveling salesman problem through an input device, which is not shown (Step S101).

Next, the assignment unit 102 of the assignment device 100 represents the traveling salesman problem with the input number of cities as the QUBO problem in the form of the expression (2) stored in advance, and assigns binary variables (QUBO variables) x to nodes of a Chimera graph (Step S102). Only information as to which variable and which variable appear as a product in the expression (2) is necessary, and specific values of W and C are not necessary. The assignment unit 102 performs assignment as described above by using the assignment expression (the expression (6), (7), (8), (9), (10)) according to the value of N.

Then, the output unit 103 of the assignment device 100 outputs information indicating a correspondence between binary variables and nodes on the basis of assignment results by the assignment unit 102 (Step S103). This information may be output to an output device such as a display, which is not shown, or may be output as an electronic file.

The flow of the computation of the traveling salesman problem (QUBO problem) by the computation system 10 is described hereinbelow. In the case of solving the problem by using the quantum annealing machine 200, the flow of the operation is as shown in the flowchart of FIG. 17.

First, the output (a list of assignments) of the assignment device 100 and the output (coefficients of QUBO variables) of the computation device 300 are input to the input/output device 400 (Step S201). Further, in Step S201, a user specifies the strength (chain strength) of coupling between qubits corresponding to the edge that connects nodes in the chain and inputs the value of the strength to the input/output device 400. The chain strength specified here is the same in all chains.

Next, the input/output device 400 determines qubits to use in the quantum annealing machine 200 and calculates the strength of coupling between qubits by using the list of assignment, the coefficients of the QUBO variables, and the chain strength (Step S202). This calculation is easily done using the above-described three inputs. The strength of coupling between qubits calculated here includes the strength of coupling corresponding to the edge in the chain, which is all equal to the specified chain strength.

The input/output device 400 inputs the list of qubits to use and the strength of coupling between qubits to the quantum annealing machine 200 (Step S203).

Then, the quantum annealing machine 200 actualizes the strength of coupling between qubits specified by input for the qubits specified by input (Step S204).

After that, the quantum annealing machine 200 performs quantum annealing. To be specific, the state of qubits in the quantum annealing machine 200 transitions from the initial state to the state that minimizes the entire energy of qubits. Although each of the qubits can be generally in two states, it is finally in either one state (Step S205).

A list of the states of the qubits here is then output from the quantum annealing machine 200 to the input/output device 400 (Step S206).

The input/output device 400 converts the list of the states of the qubits into a list of the values of the QUBO variables (Step S207). A result of conversion is x_00=0, x_01=1, . . . , for example.

The input/output device 400 outputs this list (Step S208). This list may be output to an output device such as a display, which is not shown, or may be output as an electronic file.

### [Description of Effects]

In this embodiment, the assignment device 100 assigns variables in the QUBO problem representing the traveling salesman problem to nodes of a Chimera graph. As described earlier, the assignment of this embodiment allows reducing the use of nodes that do not contribute to a product of variables in the QUBO problem. Specifically, the placement of chains in the Chimera graph is designed to reduce the nodes satisfying the following constraint (which are referred to as node a). The constraint is that, for every chain connected with the node a by edges, QUBO variables assigned to this chain and QUBO variables assigned to the chain to which the node a belongs do not appear as a product in the objective function. In this embodiment, the number of nodes satisfying the above constraint is (p−1)(N−4) or (p−1)(N−4)+p in each chain. Note that, however, there are ((N−1)²−8p) chains where the number of nodes satisfying the above constraint is (p−1)(N−4), and there are 8p chains where the number of nodes satisfying the above constraint is (p−1)(N−4)+p. For example, when N=9, the number of nodes satisfying the above constraint is 0 or 1. On the other hand, it is 5 or 6 in the assignment according to Non Patent Literature 1. The number of nodes contained in the chain is thereby reduced. For example, when N=9, the number of nodes contained in each chain is 12 in this embodiment, and it is 17 in the assignment according to Non Patent Literature 1. This reduces the number of nodes to use to represent the QUBO problem corresponding to the traveling salesman problem on a Chimera graph. In other words, the assignment device 100 obtains a correspondence between variables in the QUBO problem corresponding to the traveling salesman problem and nodes of the graph for solving this QUBO problem with a reduced number of nodes to use. This improves the correctness of solutions when solving the traveling salesman problem represented in the Chimera graph by quantum annealing.

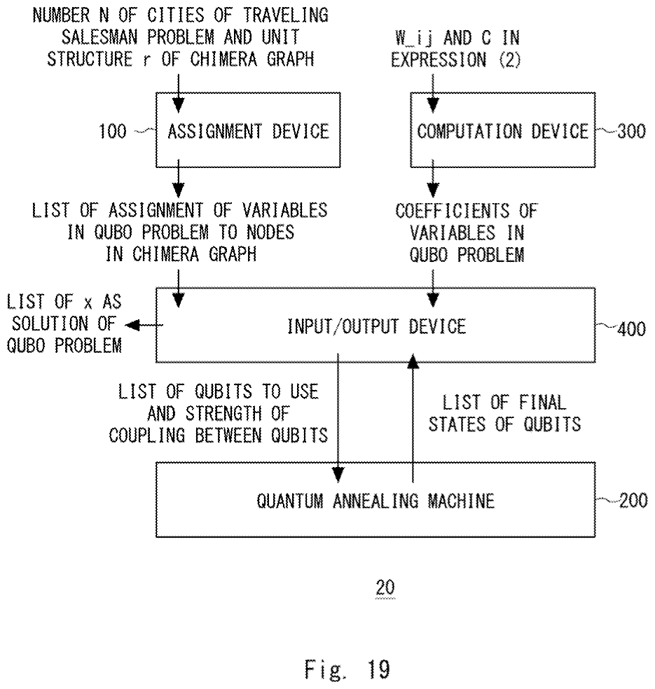

Results based on this embodiment and results based on the method of Non Patent Literature 1 are compared below. When the number of cities is less than 6, the structure of chains in the Chimera graph and which nodes are to be contained in the same chain are the same as those in the method of Non Patent Literature 1. On the other hand, when the number of cities is 6 or more, the structure of chains is different from that in the method of Non Patent Literature 1. FIG. 18 is a table showing experimental results regarding the traveling salesman problem where the number of cities is 8.

In this experiment, QUBO variables corresponding to the traveling salesman problem where the number of cities is 8 are assigned onto a Chimera graph of a quantum annealing machine adopting the Chimera graph with K(4) unit cells by the method according to this embodiment, and this problem is solved using the quantum annealing machine. Further, as an experiment of a comparative example, assignment is performed for the same problem also by the method using the technique disclosed in Non Patent Literature 1, and this problem is solved using the quantum annealing machine. In the experiment according to this embodiment and the experiment according to the comparative example, settings of the quantum annealing machine are the same except for parameters related to assignment.

Even when the number of cities is the same, the traveling salesman problem becomes a different problem if the location of cities, i.e., the distance between cities, is different. In this example, 100 problems where the number of cities is 8 and the distance between cities is different are generated at random, and each of the problems is solved by the experiment in this embodiment and the experiment in the comparative example. Solving the problems is to find the ordering of visits with the shortest route that visits all cities in given locations and returns to the first city to visit. For all of the problems used in the experiment, a correct solution is already found by calculating the total distance of all of the ordering of visits. The correct solution is the ordering of visits with the shortest total distance.

The table shown in FIG. 18 shows the number of problems for which correct solutions are obtained and the number of problems for which solutions whose error from correct solutions is within a specified range (1% and 10%) are obtained out of 100 problems. An error from a correct solution is an error of the total distance of the ordering of visits of cities in a solution obtained by the quantum annealing machine from the total distance of the ordering of visits in a correct solution. An error 1% means that the total distance given by the obtained solution is 101% of the total distance of the correct ordering of visits. As shown in FIG. 18, performing assignment by this embodiment is more likely to yield correct solutions and approximate solutions compared with the comparative example. The reason of this difference is considered due to a difference in the number of nodes to use. In this experiment, whereas the number of nodes used is 539 in this embodiment, it is 686 in the comparative example.

### Second Embodiment

In the first embodiment, the number of nodes in a unit cell of a Chimera graph is determined in advance. Specifically, the assignment device 100 according to the first embodiment performs assignment of binary variables based on the assumption of using a Chimera graph with K(4) unit cells. In other words, it performs assignment of variables on the assumption of r=4. In the second embodiment, on the other hand, an assignment device that achieves assignment of binary variables to a Chimera graph defined by an arbitrary value of r is described. The value of r is an arbitrary natural number.

FIG. 19 is a schematic view showing an example of a computation system 20 according to the second embodiment. This embodiment is different from the first embodiment in that the assignment device 100 receives as input the value of the parameter r that defines the structure of a unit cell in addition to the number N of cities, and assigns binary variables to nodes of a Chimera graph defined by the input value of r. Specifically, in the second embodiment, the input receiving unit 101 receives as input the number N of cities of the traveling salesman problem and the value of the parameter r that defines the structure of a Chimera graph (unit cell). Then, in the second embodiment, the assignment unit 102 assigns binary variables of the QUBO problem representing the traveling salesman problem with the number N of cities to the nodes of the Chimera graph consisting of K(r) unit cells defined by the value of r received by the input receiving unit 101. To be specific, the assignment unit 102 uses the value received by the input receiving unit 101 as the value of r appearing in the following description. In the second embodiment, it is assumed that the graph structure of qubits of the quantum annealing machine 200 is the structure of the Chimera graph with K(r). Thus, for example, a user enters the value of r corresponding to the quantum annealing machine 200 to the assignment device 100.

The second embodiment is the same as the first embodiment except for those described above, and therefore redundant description is omitted as appropriate. At r=4, the description involving expressions in the first embodiment and the description involving expressions in the second embodiment coincide.

An assignment method according to this embodiment is specifically described hereinafter. First, in order to specifically describe the assignment method, numbers are given to the positions of nodes in the Chimera graph consisting of K(r) unit cells. Let the k-th node of a unit cell in row m and column n be (L×m+n)×2r+k. A function f_r(m, n, k) that gives the numbers of corresponding nodes when m, n, and k are defined is represented by the expression (11). Stated differently, an identification number f_ᵣ(m,n,k) of the k-th node of the unit cell in row m and column n of the Chimera graph when a unit cell, which is a unit graph that constitutes the Chimera graph, consists of 2r nodes is represented by the following expression (11).

fᵣ(m,n,k)=(Lm+n)×2r+k Expression (11)

In the expression (11), m, n and k are integers of 0 or more. In this embodiment, binary valuables are assigned to the Chimera graph with K(r) unit cells, and therefore k=0, 1, 2, . . . , 2r−1. The upper limit of m and n is L−1. Thus, m, n=0, 1, 2, . . . , L−1. L is any integer greater than N×N/4.

As in the first embodiment, in the first process, it is determined which nodes are to be contained in one chain by the same method as Non Patent Literature 1. Each chain is distinguished by s (s is an integer of 0 or more). Since the structure of the unit cell of the Chimera graph used is different from that in the first embodiment, nodes to be contained in the s-th chain are nodes represented by the expression (12). Thus, in the first process, nodes to be contained in the s-th chain are nodes represented by the following expression (12), and thereby the nodes that form the chain are determined.

fᵣ(t,0,u+r),fᵣ(t,1,u+r),fᵣ(t,2,u+r), . . . ,fᵣ(t,t,u+r),fᵣ(t,t,u),fᵣ(t+1,t,u),fᵣ(t+2,t,u), . . . ,fᵣ(L−1,t,u) Expression (12)

t and u are uniquely determined by the value of s. t is the greatest integer (t=floor(s/r)) of s/r or less, and u is the remainder of dividing s by r (u=s−r×floor(s/r)). The relationship s=r×t+u holds true. From those relational expressions, each chain is distinguished by the number s, and it is also represented as (t, u). For example, the chain 1 is also represented as the chain (0, 1). The expression (12) is written in the sequence of nodes connected by an edge. Thus, in the expression (12), each node is directly connected by an edge to a node written adjacent to it, and not connected to a node not written adjacent to it.

In the structure of this chain, only the unit cell in row m and column n that satisfies n≤m≤N−2 is used. There are 2r chains that contain the nodes of the unit cell in row m and column n: chains (m, 0), (m, 1), . . . , (m, r−1), (n, 0), (n, 1), . . . , (n, r−1). Particularly, the first r chains use r nodes arranged vertically in the unit cell, and the remaining r chains use r nodes arranged horizontally in the unit cell.

In the case of 4≤N≤r+1, the variable x_i,a is assigned to the s-th chain that is determined by the relationship of s=r×a+i in the second process. The nodes of the s-th chain are determined in the first process, which are specifically given in the expression (12).

As in the first embodiment, in the third process, nodes f_r(N−1, a, i), f_r(N, a, i), f_r(N+1, a, i), . . . , f_r(L−1, a, i) are removed from the chain (a, i) corresponding to the variable x_i,a. This is because the chain to which those nodes are connected by an edge does not correspond to any variable of the objective function. In the case of 4≤N≤r+1, the fourth process is not performed.

In order to realize the assignment corresponding to the above processes, in the case of 4≤N≤r+1, the assignment unit 102 of the assignment device 100 assigns the variable x_i,a of the QUBO problem in the expression (2) to N number of nodes represented in the following expression (13) for the input N.

x_{i,a}: fᵣ(a,a,i),fᵣ(a+1,a,i), . . . ,fᵣ(N−2,a,i),fᵣ(a,0,i+r),fᵣ(a,1,i+r), . . . ,fᵣ(a,a,i+r) Expression (13)

The expression (13) is an extension of the expression (6). The unit cell to use is the same, and only the nodes to use in the unit cell are changed. Reflecting a change of the unit cell of the Chimera graph from K(4) to K(r), i+4 in the expression (6) is replaced with i+r in the expression (13). The same change is made to the assignment expressions described hereinbelow.

Consider next the case of r+2≤N≤2r+1. In the case of r+2≤N≤2r+1, the variable x_i,a with i=0, 1, 2, . . . , r−1 is assigned to the s-th chain that is determined by the relationship of s=r×a+i in the second process. Further, the variable x_i,a with i=r, r+1, . . . , N−2 is assigned to the s-th chain that is determined by the relationship of s=r×(N−1+a)+i−r. The nodes of the s-th chain are determined in the first process, which are specifically given in the expression (12).

Nodes that are connected by an edge only to a chain corresponding to a QUBO variable not appearing as a product in the objective function are concentrated near the end of the chain, and those nodes are removed from the chain in the third process. The nodes to be removed are in the same unit cell as that in the first embodiment, and the position of the node in the unit cell is i+r when it is i+4 in the first embodiment, and i−r when it is i−4 in the first embodiment. Specifically, in the case of i=0, 1, . . . , r−1, the nodes f_r(N+a+1, a, i), f_r(N+a+2, a, i), . . . , f_r(L−1, a, i) are removed from the chain corresponding to the variable x_i,a. In the case of i=r, r+1, . . . , N−2, the nodes f_r(N−1+a, 0, i), f_r(N−1+a, 1, i), . . . , f_r(N−1+a, a−2, i) and f_r(2N−2, N−1+a, i−r), f_r(2N−1, N−1+a, i−r), . . . , f_r(L−1, N−1+a, i−r) are removed from the chain corresponding to the variable x_i,a.

In the fourth process, blocks are shifted as in the first embodiment. The unit cells contained in each block are the same as those in the first embodiment. The above-described block 800A is a block corresponding to a group of nodes used only by the chain corresponding to x_i,a where i=0, 1, 2, . . . , r. The above-described block 800B is a block corresponding to a group of nodes used only by the chain corresponding to x_i,a where i=r+1, r+2, . . . , N−2. The above-described block 800C is a block corresponding to a group of nodes used by the chain and not belonging to any of the block 800A and the block 800B. The nodes in the block 800C that directly contribute to the product of QUBO variables of the objective function are located in unit cells in row (N−2+a) and column a, in row (N−1+a) and column a, and in row (N+a) and column a where a=0, 1, . . . , N−2. The above-described block 800E corresponds to the group of nodes in those unit cells. In the shift of the block, the nodes used by the chain of the variable x_i,a (where i=r, r+1, . . . , N−2) are changed, and the rules for this change are the same as those in the first embodiment except for a certain rule. What is different is the shift of the position of a node in the unit cell. In the second embodiment, the position of the node in the unit cell shifts from k to k′, and k′=k+r when k<r, and k′=k−r when k≥r. Thus, the group of nodes of the block 800A shifts by two unit cells in the direction of increasing the row number along the column direction. Then, nodes to be used are changed in such a way that the nodes represented by f_r(n−(N−1), m−(N−3), k′) (k′=k+r when k<r and k′=k−r when k≥r) are used instead of the nodes represented by f_r(m, n, k) belonging to the block 800B. While the variable x_i,a uses f(N−1+a, N−1, i), f(N−1+a, N, i), . . . , f(N−1+a, N−1+a, i), f(N−1+a, N−1+a, i−r), f(N+a, N−1+a, i−r), f(N+a+1, N−1+a, i−r), . . . , f(2N−3, N−1+a, i−r) before shift, it uses f(0, a+2, i−r), f(1, a+2, i−r), . . . , f(a, a+2, i−r), f(a, a+2, i), f(a, a+3, i), . . . , f(a, N, i) after shift. Further, nodes to be used are changed in such a way that the nodes represented by f_r(n+2, m−(N−3), k′) (k′=k+r when k<r and k′=k−r when k≥r) are used instead of the nodes represented by f_r(m, n, k) belonging to the block 800E. To be specific, while the variable x_i,a uses f(N−2+a, a, i), f(N−1+a, a, i), f(N+a, a, i) before shift, it uses f(a+2, a+1, i+r), f(a+2, a+2, i+r), f(a+2, a+3, i+r) after shift. The assignment unit 102 thereby connects, not through an unnecessary node, a first chain segment and a second chain segment of a chain containing the first chain segment and the second chain segment connected through the unnecessary node, and removes this unnecessary node.

By the above-described four processes, the final assignment performed by the assignment device 100 is obtained. In order to realize the assignment corresponding to the above processes, in the case of r+2≤N≤2r+1, the assignment unit 102 of the assignment device 100 assigns the variable x_i,a of the QUBO problem in the expression (2) to nodes as follows for the input N. Specifically, the assignment unit 102 assigns the variable x_i,a with any one of i=0, 1, . . . , r−1 to (N+3) nodes represented in the expression (14). Further, the assignment unit 102 assigns the variable x_i,a with any one of i=r, r+1, . . . , N−2 to (N+3) nodes represented in the expression (15).

x_{i,a}: fᵣ(a+2,a,i),fᵣ(a+3,a,i), . . . ,fᵣ(N,a,i),fᵣ(a+2,0,i+r),fᵣ(a+2,1,i+r), . . . ,f(a+2,a+3,i+r) Expression (14)

x_{i,a}: fᵣ(0,a+2,i−r),fᵣ(1,a+2,i−r), . . . ,fᵣ(a+3,a+2,i−r),fᵣ(a,a+2,i),fᵣ(a,a+3,i), . . . , f(a,N,i) Expression (15)

Consider next the case of N that satisfies 2r (p−1)+2≤N≤2rp+1. p is a natural number of 2 or more. In the second process, the variable x_i,a with i=0, 1, 2, . . . , rp−1 is assigned to the s-th chain that is determined by the relationship of s=r×p×a+i in the second process. Further, the variable x_i,a with i=rp, rp+1, . . . , N−2 is assigned to the s-th chain that is determined by the relationship of s=rp×(N−1+a)+i−rp. The nodes of the s-th chain are determined in the first process, which are specifically given in the expression (12).

As in the case of p=1, nodes that can be removed from the chain are concentrated near the end of the chain in the assignment up to this process, and those nodes are removed from the chain in the third process. Specifically, the following nodes are removed. In the case of i=0, 1, 2, . . . , rp−1, the nodes that are at the end of the chain corresponding to the variable x_i,a and can be removed are f_r(p(N+a+1), pa+i//r, i % r), f_r(p(N+a+1)+1, pa+i//r, i % r), . . . , f_r(L−1, pa+i//r, i % r), where // and % represent the meaning described above. In the case of i=rp, rp+1, . . . , N−2, the nodes that are at the end of the chain and can be removed are f_r(p(N−1+a)+i//r−p, 0, i % r+r), f_r(p(N−1+a)+i//r−p, 1, i % r+r), . . . , f_r(p(N−1+a)+i//r−p, p(a−1)−1, i % r+r) and f_r(p(2N−2), p(N−1+a)+i//r−p, i % r), f_r(p(2N−2)+1, p(N−1+a)+i//r−p, i % r), . . . , f_r(L−1, p(N−1+a)+i//r−p, i % r).

In the fourth process also, blocks are taken into consideration as in the case of p=1. The above-described block 800A is a block corresponding to a group of nodes used only by the chain corresponding to x_i,a where i=0, 1, . . . , rp−1. The above-described block 800B is a block corresponding to a group of nodes used only by the chain corresponding to x_i,a where i=rp, rp+1, . . . , N−2. The above-described block 800C is a block corresponding to a group of nodes composed of nodes used by the chain and not belonging to any of the block 800A and the block 800B. The nodes in the block 800C that directly contribute to the product of QUBO variables of the objective function are located in unit cells in row q(N−2+a) and column qa, in row q(N−1+a) and column qa, and in row q(N+a) and column qa, where a=0, 1, . . . , N−2 and q=1, 2, . . . , p. The above-described block 800E is a block corresponds to the group of nodes of those unit cells. In the fourth process, the block is shifted as follows. The group of nodes of the block 800A shifts by 2p unit cells in the direction of increasing the row number along the column direction. Then, nodes to be used are changed in such a way that the nodes represented by f_r(n−p(N−1), m−p(N−3), k′) (k′=k+r when k<r and k′=k−r when k≥r) are used instead of the nodes represented by f_r(m, n, k) belonging to the block 800B. While the variable x_i,a uses f_r(p(N−1+a)+i//r−p, p(N−1), i % r+r), f_r(p(N−1+a)+i//r−p, N, i % r+r), . . . , f_r(p(N−1+a)+i//r−p, p(N−1+a)+i//r−p, i % r+r), f_r(p(N−1+a)+i//r−p, p(N−1+a)+i//r−p, i % r), f_r(p(N−1+a)+i//r−p+1, p(N−1+a)+i//r−p, i % r), f_r(p(N−1+a)+i//r−p+2, p(N−1+a)+i//r−p, i % r), . . . , f_r(p(2N−2)−1, p(N−1+a)+i//r−p, i % r) of the block 800B before shift, it uses f_r(0, p(a+2)+i//r−p, i % r), f_r(1, p(a+2)+i//r−p i % r), . . . , f_r(pa+i//r−p, p(a+2)+i//r−p, i % r), f_r(pa+i//r−p, p(a+2)+i//r−p, i % r+r), f_r(pa+i//r−p, p(a+2)+i//r−p+1, i % r+r), . . . , f_r(pa+i//r−p, p(N+1)−1, i % r+r) after shift.

Further, nodes to be used are changed in such a way that the nodes represented by f_r(n+2p, m−p(N−3), k′) (k′=k+r when k<r and k′=k−r when k≥r) are used instead of the nodes represented by f_r(m, n, k) belonging to the block 800E. Thus, while the variable x_i,a with i=0, 1, . . . , rp−1 uses f_r(p(N−2+a)+i//r, pa+i//r, i % r), f_r(p(N−2+a)+i//r+1, pa+i//r, i % r), . . . , f_r(p(N+a+1)−1, pa+i//r, i % r) before shift, it uses f_r(p(a+2)+i//r, p(a+1)+i//r, i % r+r), f_r(p(a+2)+i//r, p(a+1)+i//r+1, i % r+r), f_r(p(a+2)+i//r, p(a+1)+i//r+2, i % r+r), . . . , f_r(p(a+2)+i//r, p(a+r)−1, i % r+r) after shift. The assignment unit 102 thereby connects, not through an unnecessary node, a first chain segment and a second chain segment of a chain containing the first chain segment and the second chain segment connected through the unnecessary node, and removes this unnecessary node.

By the above-described four processes, the final assignment performed by the assignment device 100 is obtained.

In order to realize the assignment corresponding to the above processes, in the case of N satisfying 2r (p−1)+2≤N≤2rp+1 where p is a natural number of 2 or more, the assignment unit 102 of the assignment device 100 assigns the variable x_i,a of the QUBO problem to nodes as follows for the input N. Specifically, the assignment unit 102 assigns the variable x_i,a with any one of i=0, 1, . . . , r−1 to p (N+3) nodes represented by the expression (16), and assigns the variable x_i,a with any one of i=rp, rp+1, . . . , r(p+1)−1 to p (N+3) nodes represented by the expression (17).

x_{i,a}: fᵣ(pa+2p,pa,i),fᵣ(pa+2p+1,pa,i), . . . ,fᵣ(p(N+1)−1,pa,i),fᵣ(pa+2p,0,i+r),fᵣ(pa+2p,1,i+r), . . . ,f(pa+2p,pa+4p−a,i+r) Expression (16)

x_{i,a}: fᵣ(0,pa+2p,i−rp),fᵣ(1,pa+2p,i−rp), . . . ,fᵣ(pa+4p−1,pa+2p,i−rp),fᵣ(pa,pa+2p,i−r(p−1)),fᵣ(pa,pa+2p+1,i−r(p−1)), . . . ,f(pa,p(N+1)−1,i−r(p−1) Expression (17)

The case where p is an integer of 2 or more is considered above, and there are variables x_i,a with i other than i=0, 1, . . . , r−1, rp, rp+1, . . . , r(p+1)−1 assigned by the expression (16) and the expression (17), which are not yet assigned. Using an integer q satisfying 1≤q≤p, i of the unassigned variables x_i,a is represented as i=rq, rq+1, . . . , r(q+1)−1, r(p+q), r(p+q)+1, . . . , r(p+q+1)−1. The variables x_i,a with i=rq, rq+1, . . . , r(q+1)−1 (1≤q<p) are assigned to the nodes sequentially in ascending order of the value of q. Consider first x_i,a(i=r, r+1, . . . , 2r−1) with q=1. Consider therefore the node to which x_i−r,a is assigned. i−r=0, 1, . . . , r−1, and x_i−r,a is already assigned to the node by the expression (16). From the nodes to which x_i−r,a is assigned, they are shifted in parallel by +1 in row and +1 in column of the unit cells. Specifically, if one of the nodes to which x_i−r,a is assigned is f_r(m, n, k), it is shifted to f_r(m+1, n+1, k). x_i,a is then assigned to the node at the position after it is shifted in parallel in this way. Since there are p(N+3) number of nodes to which x_i−r,a is assigned, x_i,a is assigned to nodes at positions after those nodes are shifted in parallel in the same manner. Note that, however, when the node to which the variable is assigned is the node represented as f_r(p(N+1), pa+q, i−rq), x_i,a is not assigned to this node. Alternatively, x_i,a is assigned to the node represented by f_r(pa+2p+q, pa+q, i−r(q−1)). The same assignment is performed up to q=p, with q incremented by 1 each time.

After that, x_i,a with i=r(p+q), r(p+q)+1, . . . , r(p+q+1)−1, (1≤q<p) are assigned to nodes. Consider q=1 first. In the same manner as above, x_i,a is assigned to nodes at positions after they are shifted in parallel by +1 in row and +1 in column of the unit cell from the node to which x_i−r,a is assigned. Note that, however, when the node to which the variable is assigned is the node represented as f_r(pa+q, p(N+1), i−r(p+q−1)), x_i,a is not assigned to this node. Alternatively, x_i,a is assigned to the node represented by f_r(pa+q, pa+2p+q, i−r(p+q)). The same assignment is performed up to q=p, with q incremented by 1 each time. As described above, the assignment unit 102 of the assignment device 100 assigns all variables x_i,a to nodes.

### [Description of Operation]

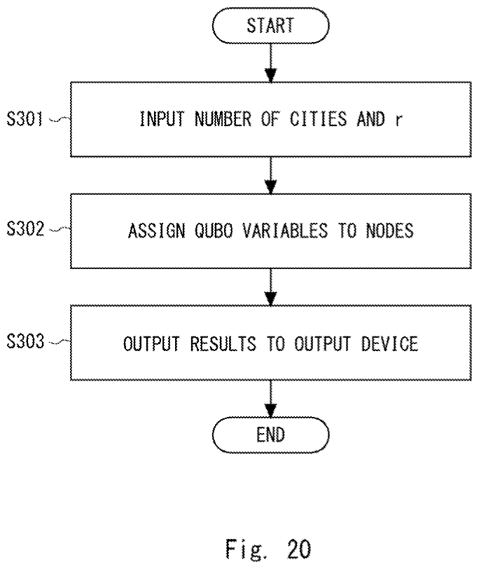

The operation of this embodiment is described hereinafter with reference to the drawings. FIG. 20 is a flowchart showing the flow of the operation of the assignment device 100 according to the second embodiment. The flow of the operation of the assignment device 100 according to the second embodiment is described hereinafter with reference to FIG. 20.

First, the input receiving unit 101 of the assignment device 100 receives as input the number N of cities of the traveling salesman problem and the value of r that characterizes the structure of unit cells of a Chimera graph through an input device, which is not shown (Step S301).

Next, the assignment unit 102 represents the traveling salesman problem with the input number of cities as the QUBO problem in the form of the expression (2) stored in advance, and assigns binary variables (QUBO variables) x to nodes of the Chimera graph defined by the input value of r (Step S302). The unit cells used for assignment are not dependent on r, and they are the same as those of the first embodiment. The condition that the unit cells are not dependent on r means that when unit cells used for assignment are specified by row number m and column number n, the values of m and n do not depend on the value of r. Only the positions of nodes used in the unit cell depend on the value of r. The assignment unit 102 performs assignment as described above by using the assignment expression (the expression (13), (14), (15), (16), (17)) according to the value of N.

The output unit 103 of the assignment device 100 outputs information indicating a correspondence between binary variables and nodes on the basis of assignment results by the assignment unit 102 (Step S303). This information may be output to an output device such as a display, which is not shown, or may be output as an electronic file.

In the case of solving the QUBO problem by using the quantum annealing machine 200, the same operation as the operation described with reference to FIG. 17 in the first embodiment is performed.

The second embodiment is described above. This embodiment enables assignment of variables in the QUBO problem corresponding to the traveling salesman problem to nodes of the Chimera graph having unit cells defined by an arbitrary value of r with a smaller number of nodes to use.

Note that the present disclosure is not limited to the above-described embodiments and can be modified as appropriate without departing from the spirit and scope of the present disclosure.

According to the present disclosure, there are provided an assignment device, an assignment method, and a program capable of obtaining the correspondence that reduces the number of nodes to use as a correspondence between variables in a QUBO problem corresponding to the traveling salesman problem and nodes of a graph for solving this QUBO problem.

The first and second embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An assignment device comprising:
at least one memory storing instructions; and
at least one processor configured to execute the instructions to:
receive as input the number of cities of a traveling salesman problem;
assign, to nodes of a Chimera graph, binary variables according to the number of cities of the traveling salesman problem represented as a QUBO (Quadratic Unconstrained Binary Optimization) problem; and
output information indicating a correspondence between the binary variables and the nodes on the basis of an assignment result of the binary variables to the nodes,
wherein the processor is further configured to execute the instructions to assign, to the nodes connected to each other by an edge in the Chimera graph, a pair of the binary variables appearing as a product in an objective function of the QUBO problem in preference to a pair of binary variables not appearing as a product in the objective function of the QUBO problem.

2. The assignment device according to claim 1, wherein
the processor is further configured to execute the instructions to:
determine nodes to form a chain in such a way that all the nodes in one chain share the same unit cell as the nodes in a specific number of other chains, where the chain is a group of nodes connected by an edge, and the unit cell is a unit graph constituting the Chimera graph;
assign the binary variables to the chain in such a way that at least one specific node is placed at an end of the chain, where the specific node is the node not connected by the edge to a chain to which the binary variable appearing as a product in the objective function of the QUBO problem is assigned;
remove the specific node from the end of the chain; and
determine final assignment of the binary variables to the nodes by changing nodes to form the chain in the Chimera graph in such a way a first chain segment and a second chain segment of the chain connected through the specific node remaining unremoved become connected not through the specific node, and removing the specific node from the chain.

3. The assignment device according to claim 1, wherein the objective function is represented by H of a first expression, and the binary variables of the QUBO problem are x distinguished by a subscript in the first expression,
$$H = {\sum }_{i , j = 0}^{N - 2} {\sum }_{a = 0}^{N - 3} {W}_{ij} {x}_{i , a} {x}_{j , a + 1} + {\sum }_{i = 0}^{N - 2} {W}_{i , N - 1} {x}_{i , N - 2} + {\sum }_{j = 0}^{N - 2} {W}_{N - 1 , j} {x}_{j , 0} + C {\sum }_{a = 0}^{N - 2} {( {\sum }_{i = 0}^{N - 2} {x}_{i , a} - 1 )}^{2} + C {\sum }_{i = 0}^{N - 2} {( {\sum }_{a = 0}^{N - 2} {x}_{i , a} - 1 )}^{2}$$
where N is the number of cities of the traveling salesman problem, x_{i,a} is a variable representing whether or not to visit city i as a-th city to visit, Wᵢⱼ is an integer representing a distance between city i and city j, and C is a predetermined positive value.

4. The assignment device according to claim 3, wherein
when a unit cell being a unit graph constituting the Chimera graph is composed of 2r (r is a natural number) number of the nodes, and an identification number fᵣ(m,n,k) of the k-th node of the unit cell in row m and column n of the Chimera graph is represented by a following second expression,
the processor is further configured to execute the instructions to, in a case of r+2≤N≤2r+1, assign binary variables x_{i,a} with i being any of 0, 1, . . . , r−1 to (N+3) number of nodes represented by a following third expression, and assign binary variables x_{i,a} with i being any of r, r+1, . . . , N−2 to (N+3) number of nodes represented by a following fourth expression.
fᵣ(m,n,k)=(Lm+n)×2r+k Second Expression
where m, n, k are integers of 0 or more, L is an integer, and an upper limit of m and n is L−1,
x_{i,a}: fᵣ(a+2,a,i),fᵣ(a+3,a,i), . . . ,fᵣ(N,a,i),fᵣ(a+2,0,i+r),fᵣ(a+2,1,i+r), . . . ,f(a+2,a+3,i+r) Third Expression
x_{i,a}: fᵣ(0,a+2,i−r),fᵣ(1,a+2,i−r), . . . ,fᵣ(a+3,a+2,i−r),fᵣ(a,a+2,i),fᵣ(a,a+3,i), . . . , f(a,N,i) Fourth Expression

5. The assignment device according to claim 3, wherein
when a unit cell being a unit graph constituting the Chimera graph is composed of 2r (r is a natural number) number of the nodes, and an identification number fᵣ(m,n,k) of the k-th node of the unit cell in row m and column n of the Chimera graph is represented by a following second expression,
the processor is further configured to execute the instructions to: in a case of 2r (p−1)+2≤N≤2rp+1 (p is a natural number of 2 or more),
assign binary variables x_{i,a} with i being any of 0, 1, . . . , r−1 to p(N+3) number of nodes represented by a following fifth expression,
assign binary variables x_{i,a} with i being any of rp, rp+1, . . . , r(p+1)−1 to p(N+3) number of nodes represented by a following sixth expression,
assign binary variables x_{i,a} with i being any of rq, rq+1, . . . , r(q+1)−1 (q is an integer satisfying 1≤q<p) to the nodes at positions after the nodes are shifted in parallel by +1 in row and +1 in column of the unit cell from positions of the nodes to which the binary variables x_{i-r,a} are assigned, whereas if the node to which the binary variable is assigned is the node represented as fᵣ(p(N+1), pa+q, i−rq), assign the binary valuable to the node represented as fᵣ(pa+2p+q, pa+q, i−r(q−1)) instead of that former node; and
assign binary variables x_{i,a} with i being any of r(p+q), r(p+q)+1, . . . , r(p+q+1)−1 (q is an integer satisfying 1≤q<p) to the nodes at positions after the nodes are shifted in parallel by +1 in row and +1 in column of the unit cell from positions of the nodes to which the binary variables x_{i-r,a} are assigned, whereas if the node to which the binary variable is assigned is the node represented as fᵣ(pa+q, p(N+1), i−r(p+q−1)), assign the binary valuable to the node represented as fᵣ(pa+q, pa+2p+q, i−r(p+q)) instead of that former node.
fᵣ(m,n,k)=(Lm+n)×2r+k Second Expression
wherein m, n, k are integers of 0 or more, L is an integer, and an upper limit of m and n is L−1.
x_{i,a}: fᵣ(pa+2p,pa,i),fᵣ(pa+2p+1,pa,i), . . . ,fᵣ(p(N+1)−1,pa,i),fᵣ(pa+2p,0,i+r),fᵣ(pa+2p,1,i+r), . . . ,f(pa+2p,pa+4p−a,i+r) Fifth Expression
x_{i,a}: fᵣ(0,pa+2p,i−rp),fᵣ(1,pa+2p,i−rp), . . . ,fᵣ(pa+4p−1,pa+2p,i−rp),fᵣ(pa,pa+2p,i−r(p−1)),fᵣ(pa,pa+2p+1,i−r(p−1)), . . . ,fᵣ(pa,p(N+1)−1,i−r(p−1) Sixth Expression

6. The assignment device according to claim 4, wherein the processor is further configured to execute the instructions to, in a case of 4≤N≤r+1, assign binary variables to N number of nodes represented by a following seventh expression.
x_{i,a}: fᵣ(a,a,i),fᵣ(a+1,a,i), . . . ,fᵣ(N−2,a,i),fᵣ(a,0,i+r),fᵣ(a,1,i+r), . . . ,fᵣ(a,a,i+r) Seventh Expression

7. The assignment device according to claim 4, wherein
the processor is further configured to execute the instructions to receive as input the value of r, and
uses the input value as the value of r.

8. An assignment method comprising:
receiving as input the number of cities of a traveling salesman problem;
assigning, to nodes of a Chimera graph, binary variables according to the number of cities of the traveling salesman problem represented as a QUBO problem; and
outputting information indicating a correspondence between the binary variables and the nodes on the basis of an assignment result of the binary variables to the nodes,
wherein in the assignment of the binary variables to the nodes, a pair of binary variables appearing as a product in an objective function of the QUBO problem is assigned to the nodes connected to each other by an edge in the Chimera graph in preference to a pair of binary variables not appearing as a product in the objective function of the QUBO problem.

9. A non-transitory computer readable medium storing a program causing a computer to execute:
an input receiving step of receiving as input the number of cities of a traveling salesman problem;
an assignment step of assigning, to nodes of a Chimera graph, binary variables according to the number of cities of the traveling salesman problem represented as a QUBO problem; and
an output step of outputting information indicating a correspondence between the binary variables and the nodes on the basis of an assignment result of the binary variables to the nodes,
wherein the assignment step assigns, to the nodes connected to each other by an edge in the Chimera graph, a pair of binary variables appearing as a product in an objective function of the QUBO problem in preference to a pair of binary variables not appearing as a product in the objective function of the QUBO problem.
